(19) United States
(12) Patent Application Publication
(10) Pub. No.: US 2024/0340065 A1
(43) Pub. Date: Oct. 10, 2024

(54) REPORTING OF BEAM SWEEP RECONFIGURATION

(71) Applicant: Telefonaktiebolaget LM Ericsson (publ), Stockholm (SE)

(72) Inventors: Johan RUNE, Lidingö (SE); Ali PARICHEHREHTEROUJENI, Linköping (SE); Angelo CENTONZA, Granada (ES)

(21) Appl. No.: 18/293,917

(22) PCT Filed: Jul. 15, 2022
(86) PCT No.: PCT/SE2022/050721

§ 371 Date: Jan. 31, 2024

Related U.S. Application Data
(60) Provisional application No. 63/229,971, filed on Aug. 5, 2021.

(51) Int. Cl. H04B 7/06; H04W 74/0833

(52) U.S. Cl. CPC H04B 7/06952; H04W 74/0833

(57) ABSTRACT

A method of operating a DU of a network node of a wireless communications network includes detecting a RACH configuration conflict for a cell served by the DU in which SSBs having different SSB indices are transmitted using a plurality of spatial beams according to a beam sweeping timing, changing the beam sweeping timing of the cell from an original beam sweeping timing to a new beam sweeping timing in response to detecting the RACH conflict, and signalling the new beam sweeping timing to a CU of the network node. Signalling the new beam sweeping timing to the CU includes signalling to the CU an indication of SSBs affected by the changing of the beam sweeping timing.

### TECHNICAL FIELD

The present application relates to wireless communication networks, and in particular to wireless communication networks that communicate using spatial beams.

### BACKGROUND

The 5G radio access network (NG-RAN) architecture is illustrated in FIG. 1. As shown therein, the NG-RAN consists of a set of gNodeBs (gNBs) 205 connected to the 5G core network (5GC) via the NG logical interface. A gNB 205, which can support frequency division duplexing (FDD) mode, time division duplexing (TDD) mode or dual mode operation, may consist of a central unit (gNB-CU, or CU) 210 and one or more distributed units (gNB-DU or DU) 220. A gNB-CU 210 and a gNB-DU 220 are inter-connected via the F1 logical interface, while the gNBs 205 can be interconnected through the Xn logical interface. One gNB-DU is connected to only one gNB-CU. For resiliency, a gNB-DU may be connected to multiple gNB-CU by appropriate implementation.

The NG-RAN is layered into a Radio Network Layer (RNL) and a Transport Network Layer (TNL). The NG-RAN architecture, i.e. the NG-RAN logical nodes and interfaces between them, is defined as part of the RNL. For each NG-RAN interface (NG, Xn, F1) the related TNL protocol and the functionality are specified. The TNL provides services for user plane transport and control plane (signaling) transport. If security protection for control plane and user plane data on TNL of NG-RAN interfaces has to be supported, NDS/IP (3GPP TS 33.401) shall be applied.

A gNB may also be connected to a Long Term Evolution (LTE) eNB via the X2 interface. Another architectural option is that where an LTE eNB connected to the Evolved Packet Core network is connected over the X2 interface with a so called en-gNB. The latter is a gNB not connected directly to a CN and connected via X2 to an eNB for the sole purpose of performing dual connectivity.

The architecture in FIG. 1 can be expanded by spitting the gNB-CU into two entities as illustrated in FIG. 2, which illustrates a split gNB architecture in NG-RAN. As shown in FIG. 2, a gNB 205 includes a gNB-CU-CP 210a that handles control plane signalling and a gNB CU-UP 210b that handles user plane signalling. The gNB 205 includes two distributed units, gNB-DU 220.

As further shown in FIG. 2, in the split architecture option, the RAN protocol stack functionality is separated in different parts for control plane (CP) and user plane (UP) operations. The gNB-CU-CP 210a (or CU-CP 210a) is expected to handle the radio resource control (RRC) layer, the gNB-CU-UP 210b (or CU-UP 210b) will handle the packet data convergence protocol (PDCP) layer and the gNB-DU(s) 220, will handle the radio link control (RLC), medium access control (MAC) and physical (PHY) layers of the protocol stack. In some further splits, the gNB-DU(s) can have separated units that handle the PHY parts separately compared to RLC and MAC layers that are handled in a gNB-DU 220.

As different units handle different protocol stack functionalities, there will be a need for inter-node communication between the gNB-DU, the gNB-CU-UP and the gNB-CU-CP. This is achieved via the F1-C interface related to control plane signaling, via the F1-U interface related to user plane signaling for communication between gNB-CU and gNB-DU and via the E1 interface for communication between gNB-CU-UP and gNB-CU-CP.

The E1 interface is a logical interface. It supports the exchange of signaling information between the endpoints. From a logical standpoint, the E1 interface is a point-to-point interface between a gNB-CU-CP and a gNB-CU-UP. The E1 interface enables exchange of user equipment (UE) associated information and non-UE associated information. The E1 interface is a control interface and is not used for user data forwarding.

### Random Access in New Radio (NR)

Random access (RA) is performed when the UE wants to transition from idle/inactive to connected state to e.g. transmit data or signaling. Similar to LTE, NR uses a four-step random access procedure consisting of the following steps:
1. UE transmits a preamble (also known as Msg1) on the physical random access channel (RACH)
2. Network responds with a random access response (RAR) (also known as Msg2) indicating reception of the preamble and providing a time-alignment command adjusting the transmission timing of the UE based on the timing of the received preamble
3-4. The UE and network exchange messages (uplink message Msg3 and subsequent downlink message Msg4) to resolve potential collisions due to simultaneous transmission of the same preamble from multiple devices within the cell. If successful, Msg4 also transfers the UE to connected state.

Once the random access is completed, the UE is in connected state and subsequent communication is performed using dedicated channels.

FIG. 3 illustrates a four-step RA procedure.

In addition to the basic 4-step random access procedure described above, NR Release 16 also supports a 2-step random access procedure consisting of only two messages MsgA and MsgB, where MsgA basically replaces Msg1+Msg3 and MsgB basically replaces Msg2+Msg4. The 2-step random access procedure reduces the idle-to-connected transition time but is in practice limited to small cells where the timing advance is 0 since the Msg3 (or PUSCH) part of MsgA is sent before the uplink timing alignment is established. FIG. 4 illustrates a two-step random access procedure.

What is described above is the so-called contention-based random access procedure where there is no coordination among the UEs and the same preamble may therefore be sent from multiple UEs at the same time. In connected mode there is also a contention-free random access procedure, which is used e.g. during handover, where the network assigns a dedicated preamble for the UE to use in the random access procedure and hence there are no collisions. However, this document mainly focuses on the contention-based random access procedure.

### PRACH Resource Configuration for 4-Step RA

For 4-step RA, the physical random access channel (PRACH) time/frequency resources are configured in system information (more specifically in the RACH-ConfigCommon IE in SIB1) and consist of a number of slots (the PRACH slots) that repeats itself every PRACH configuration period. Within these PRACH slots there may be multiple frequency domain PRACH occasions which lie consecutive in the frequency domain and each occupying a certain number of resource blocks that depends on the preamble transmission bandwidth. Two types of preamble format are defined: a long format used for larger cells and a short one for smaller cells. For the short preambles it is in some cases possible to have multiple preamble transmissions multiplexed in time within a single PRACH slot. In other words, for short preambles there may not only be multiple PRACH occasions in the frequency domain but also in the time domain. In each such PRACH time/frequency occasion there are 64 preambles available for transmission. FIG. 5 illustrates a PRACH resource structure.

A key feature of random access in NR is the possibility to establish a suitable beam pair and to apply receiver side analog beam-sweeping for the preamble reception. This is achieved by associating different Synchronization Signal Blocks (SSBs) with different PRACH time/frequency occasions and/or different preambles. As different SSBs correspond to different downlink beams, the network is able to determine the downlink beam from the preamble reception. Furthermore, if the SSBs are mapped so that at a given time all RACH occasions in frequency are mapped to the same SSB, the network will also be able to apply analog beam-sweeping for the preamble reception.

Each SSB is mapped to a number of PRACH occasions. This number can be less than one meaning that the PRACH occasion is shared by multiple SSBs (in this case separation is done based on preamble partitioning, see below), or it can be larger than one to e.g. enable analog beam-sweeping for the preamble reception. The mapping of SSBs to PRACH occasions is done in the following order:
First in increasing order of preamble indexes within a single PRACH occasion;
Then in the frequency domain for the frequency multiplexed PRACH occasions;
Then in time domain for the time multiplexed PRACH occasions within a PRACH slot (assuming short-preamble format is used);
Then finally in the time domain between PRACH slots

When the UE performs random access, it will select the first available PRACH occasion corresponding to the selected downlink beam/SSB for the preamble transmission. If there is more than one PRACH occasion to choose from (i.e. if an SSB is mapped to multiple PRACH occasions in the frequency domain) the UE will select one at random.

FIG. 6 shows an illustrative example in which there are two downlink beams/SSBs in the cell and both SSBs are mapped to the same PRACH occasion, i.e. the SSBs are separated using preamble partitioning rather than PRACH occasion partitioning in this example. There are two PRACH slots per PRACH period and six PRACH occasions per PRACH slot.

In the time domain the PRACH configuration (including the position and length of PRACH occasions) is determined by the prach-ConfiguationIndex in the RACH-ConfigGeneric IE, wherein the prach-ConfiguationIndex points at a row in one out of three tables specified in 3GPP TS 38.211 (Table 6.3.3.2-2, Table 6.3.3.2-3 and Table 6.3.3.2-4), wherein the applicable table is determined by the carrier frequency and type of duplex scheme, i.e. FDD or TDD. As an example, the first rows from Table 6.3.3.2-2 in 3GPP TS 38.211, which applies to FDD deployment in FR1, is recited below. Table 6.3.3.2-2 of TS 38.211 is reproduced below as Table 1.

TABLE 1
Table 6.3.3.2-2 of TS 38.211

| | | | | | | | Nₜ^{RA, slot}, | |
|---|---|---|---|---|---|---|---|---|
| | | | | | | | number | |
| | | | | | | | of time- | |
| | | | | | | Number of | domain | |
| | | | | | | PRACH | PRACH | |
| PRACH | | | | | | slots | occasions | N_{dur}^{RA}, |
| Configuration | Preamble | n_{SFN} mod x = y | | Subframe | Starting | within a | within a | PRACH |
| Index | format | x | y | number | symbol | subframe | PRACH slot | duration |
| 0 | 0 | 16 | 1 | 1 | 0 | — | — | 0 |
| 1 | 0 | 16 | 1 | 4 | 0 | — | — | 0 |
| 2 | 0 | 16 | 1 | 7 | 0 | — | — | 0 |
| 3 | 0 | 16 | 1 | 9 | 0 | — | — | 0 |
| 4 | 0 | 8 | 1 | 1 | 0 | — | — | 0 |
| . . . | | | | | | | | |

The 64 preambles within a PRACH occasion are divided equally among the SSBs sharing the PRACH occasion and are then split into a contention-based and a contention-free part. The contention-based preambles associated with an SSB can also be further split into an A and B group where the group B preambles are used to request a larger Msg3 size in the contention-based random access procedure. The overall division of the preambles is illustrated in FIG. 7. Note that it also possible to reserve some of the 64 preambles for other use, e.g. for (Msg1-based) on-demand system information request.

The contention-free preambles associated with an SSB are used in the contention-free random access procedure used during, for example, a handover.

As in LTE, the random access procedure for NR is described in the NR MAC specification and the related parameters are configured by RRC, e.g. in the system information or using dedicated signaling in conjunction with handover (RRCReconfiguration with reconfiguration WithSync). Random access is triggered in many different scenarios, for example, when the UE is in RRC_IDLE or RRC_INACTIVE state and wants to access a cell that is camping on (i.e. transition to RRC_CONNECTED state).

In NR, the RACH configuration is broadcast in SIB1, as part of the servingCellConfigCommon information element (IE) with both downlink (DL) and uplink (UL) configurations), where the RACH configuration is within the uplinkConfigCommon IE. The exact RACH parameters are within what is called initialUplinkBWP IE, since this is the part of the UL frequency the UE shall access and search for RACH resources.

Some further details of the RA configuration and RA procedures for 4-step RA in NR will now be described, divided into respective subsections for contention-based random access (CBRA) and contention-free random access (CFRA).

### Contention-Based (CB) 4-Step RA in NR

As previously mentioned, the RACH configuration is associated with SSB beams in NR. As a result, the random access resource selection in NR needs to be performed within a cell depending on measurements performed on SSBs (synchronization signal blocks) or CSI-RSs. An SSB consists of the PSS, SSS (where the cells physical identifier, PCI, is derived from the PSS+SSS) and a PBCH transmission carrying the master information block (MIB) and a few more so called PBCH payload bits. A cell in NR is basically defined by a set of these SSBs that may be transmitted in one or multiple downlink beams. For the same cell, these SSBs carry the same physical cell identifier (PCI) (derived from the PSS+SSS) and MIB, but they each have a unique SSB index which is conveyed by the DMRS sequence used for the PBCH transmission together with (if the maximum number of SSBs that may be configured in the cell is greater than 8) three PBCH payload bits.

For standalone operation, i.e., to support UEs camping on an NR cell, they also have an associated SIB1 which comprises the RACH configuration together with other information that is crucial for accessing the cell. This RACH configuration comprises a mapping between the detected SSB covering the UE at a given point in time and the RA configuration (e.g. PRACH time/frequency transmission resources, preamble range(s), etc.) to be used. For that, each of these beams may transmit its own SSB where each SSB has its own SSB index. FIG. 8 illustrates SSB transmission via beams.

The mapping between RACH resources and SSBs (or CSI-RS) is also provided as part of the RACH configuration (in RACH-ConfigCommon). Two paramers are relevant here:
#SSBs-per-RACH-occasion: ⅛, ¼, ½, 1, 2, 8 or 16, which represents the number of SSBs associated with each RACH occasion;
#CB-preambles-per-SSB: the number of contention-based (CB) preambles associated with each SSB within a RACH occasion. The total number of CB preambles in a RACH occasion is equal to #CB-preambles-per-SSB<=#CB-preambles-per-SSB.

Note that in the ASN.1 code in the NR RRC specification, 3GPP TS 38.331, the #SSBs-per-RACH-occasion and #CB-preambles-per-SSB parameters are integrated in the composite ASN.1 construct ssb-perRACH-Occasion AndCB-PreamblesPerSSB.

To give a first example, if the number of SSBs per RACH occasion is 1, and if the UE is under the coverage of a specific SSB e.g. the SSB with index 2, there will be a RACH occasion for that SSB index 2. If the UE moves and is now under the coverage of another specific SSB e.g. with SSB index 5, there will be another RACH occasion for that SSB index 5, i.e. each SSB detected by a given UE would have its own RACH occasion. Hence, at the network side, upon detecting a preamble in a particular RACH occasion, the network knows exactly which SSB the UE has selected and, consequently, which downlink beam is covering the UE, so that the network can continue the downlink transmission e.g. RAR, etc, using beamforming in the same direction. That factor 1 is an indication that each SSB has its own RACH occastion. That is, a preamble detected there indicates to the network which SSB the UE has selected, i.e. which DL beam the network should use to communicate with the UE, such as when sending the RAR.

FIG. 9 illustrates a one-to-one SSB to PRACH occasion mapping.

As long as #SSBs-per-RACH-occasion<=1, all preambles that are available in a cell, i.e. 64 (unless the configuration deliberately reduces the number), are also available in each PRACH occasion. These preambles are formed by different Zadoff-Chu sequences (different Zadoff-Chu root sequences and/or different cyclic shifts of each Zadoff-Chu sequence). The more contention-based (CB) preambles that are available in a RACH occasion, the lower the risk of preamble collision when multiple UEs transmits CB preambles in the same PRACH occasion. If, on the other hand, #SSBs-per-RACH-occasion>1, the available preambles are divided into subranges where each SSB associated the RACH occasion gets its own associated preamble range. The number of preambles associated with each SSB sharing a RACH occasion is determined by the #CB-preambles-per-SSB parameter.

In a second example, shown in FIG. 10, the number of SSBs per RACH occasion (#SSBs-per-RACH-occasion) is 2. Hence, a preamble received in that RACH occasion indicates to the network that one of the two beams are being selected by the UE. In this case, the preambles in the RACH occasion will be divided into two subranges, one for each of the SSBs associated with the RACH occasion. Then the preamble subrange the transmitted preamble belongs to indicates to the network which of the SSBs associated with the PRACH occasion that the UE has selected. As a possible alternative, or complement, the network may have other means via implementation to distinguish these two SSB beams and to consequently to determine the downlink beam to use towards the UE, e.g based on beam correspondence. As yet another alternative, the network may perform a beam sweeping in the downlink by transmitting the RAR in both beams, either simultaneously or transmitting the RAR in one beam at a time, possibly waiting for a response from the UE after the first transmission, and if absent, transmit the RAR in the second beam direction too.

If the number of SSBs per RACH occasion (#SSBs-per-RACH-occasion) is <1, each SSB maps on multiple RACH occasions and each RACH occasion is associated with only one SSB.

Assuming now that in the first attempt the UE has selected an SSB (based on measurements performed in that cell), transmitted with initial power a selected CB preamble associated with the PRACH resource mapped to the selected SSB, and has not received a RAR with a MAC RAR indicating a preamble index matching the one the UE used within the RAR time window. According to the standard specifications, the UE may then perform preamble re-transmission (after a new random selection of CB preamble) until a maximum allowed number of preamble transmissions is reached. If the UE did receive a RAR (albeith without a MAC RAR indicating a preamble index matching the one the UE used) and this RAR contained a Backoff Indication, the UE has to wait a time period in accordance with the Backoff Indication before re-attempting the preamble transmission.

### Contention-Free (CF) 4-Step RA in NR

In NR, as in LTE, the UF may be configured to perform 4-step CFRA e.g. during handovers. That configuration goes in the reconfiguration WithSync IE (which goes in the CellGroupConfig IE, transmitted in the RRCReconfiguration message). In particular, the 4-step CFRA configuration is contained in the CFRA IE in the RACH-ConfigDedicated IE.

A difference from the common configuration for CBRA, CFRA may be configured for only a subset of the SSBs in a cell, or for a set of CSI-RSs that may be activated solely for the purpose of supporting the handover. If none of the SSBs or CSI-RSs for which CFRA is configured is good enough (i.e. is received with an reference signal received power (RSRP) exceeding a configured threshold), the UF reverts to CBRA associated with any of the SSBs in the target cell. If an RA attempt is unsuccessful, the UE may, as previously described, re-attempt the preamble transmission and prior to each preamble transmission, the UE may select a new SSB (or CSI-RS) and may thus switch back and forth between CFRA and CBRA for each preamble transmission.

The same chapters from the NR MAC specification, 3GPP TS 38.321, that apply for 4-step CBRA are applicable for 4-step CFRA too.

### PRACH Resources for 2-Step RA

2-step RA introduced in Rel-16 use PRACH partitioning to enable the network to distinguish the 2-step RA attempts from the 4-step RA attempts in order to simplify the decoding of the Msg3 (PUSCH) part of MsgA (a.k.a. MsgA PUSCH).

The PRACH time/frequency resources (i.e. the PRACH occasions) for 2-step RA are configured in the broadcasted system information (more specifically in the RACH-ConfigCommonTwoStepRA-r16 IE in SIB1) and can either be separate from 4-step RA or they can be shared with 4-step RA. In the separate case the 2-step RA users can be distinguished based on the PRACH occasion while in the shared case this is not possible and preamble partitioning must be used instead. The preamble partitioning is done by expanding the SSB-associated contention-based preamble region and allocating the preambles in the expansion to 2-step RA. The 2-step RA preambles can then be split into an A and B group similar to the 4-step contention-based preambles. As can be seen from FIG. 11, which illustrates preamble partitioning in case of shared PRACH occasions for 4-step and 2-step RA, the end result is that the SSB-associated contention-based preambles have been split into four partitions:
4-step RA
   group A
   group B
2-step RA
   group A
   group B

Note that, if shared PRACH occasions are used for 2-step RA and 4-step RA, the SSB-associated contention-based preambles used for 2-step RA still looks like contention-free preambles to a Rel-15 UE. There is therefore no risk that a Rel-15 UE uses the 2-step RA preambles which makes the solution backwards compatible.

The RRC IEs for 2-step RA configuration corresponding to the RACH-ConfigGeneric and RACH-ConfigCommon IEs for 4-step RA are the RACH-ConfigGenericTwoStepRA-r16 and RACH-ConfigCommonTwoStepRA-r16 IEs.

The distinction between 2-step CBRA and 2-step CFRA is similar as between 4-step CBRA and 4-step CFRA. For handover, 2-step CFRA is configured in the RACH-ConfigDedicated IE, just like 4-step CFRA. In particular, the 2-step CFRA configuration is contained in the CFRA-TwoStep-r16 IE in the RACH-ConfigDedicated IE (see above).

### RACH Optimization Purpose

Optimization of the RACH configuration in cells is a Release 9 SON feature that is key to optimizing the system performance of a mobile network. A poorly configured RACH may result in higher call setup and handover delays due to frequent RACH collisions, or low preamble-detection probability and limited coverage. The amount of uplink resource reserved for RACH also affects the system capacity. Therefore, a network operator should carefully monitor that the RACH parameters are appropriately set, considering factors such as the RACH load, the uplink interference, the traffic patterns and the population under the cell coverage.

The RACH optimization feature facilitates automatic configuration of PRACH parameters (including the PRACH resource configuration, preamble root sequence and cyclic shift configuration) to avoid preamble collisions with neighboring cells The principle of this automatic configuration is similar to the automatic PCI configuration SON feature: the PRACH configuration information is included in the ‘X2 Setup’ and ‘eNB Configuration Update’ procedures in LTE. Therefore, whenever a new eNodeB is initialized and learns about its neighbors via the ANR function, it can at the same time learn the neighboring PRACH configurations. It can then select its own PRACH configuration to avoid conflicts with the neighboring ones. This is facilitated if the neighboring eNBs/cells are synchronized.

Whenever a conflict is identified, one of the cells should change its configuration, but the algorithm for selecting which cell should change and in what manner is not specified. The network operator can also combine PRACH self-optimization with manual configuration if necessary, but this is typically more prone to errors and more time consuming than automatic RACH optimization.

### Reporting of RA Information and Failures

RACH resource configuration and allocation among different cells may be performed during the network planning phase in a centralized fashion (e.g., by OAM) or in a distributed fashion (e.g., by RAN nodes such as the gNB-CUs and/or the gNB-DUs). The network may use UE assistance information in terms of RA reports (RA-Report-r16 IEs) (or RACH reports in LTE, i.e. RACH-Report-r9 IEs) for a performed RA procedure and possibly also similar information in RLF reports (RLF-Report-r16 IEs) (or RLF-Report-r9 IEs in LTE) and connection establishment failure reports (ConnEstFailReport-r16 IEs) (or ConnEstFailReport-r11 IEs in LTE).

However, the task becomes more complicated given that these factors may change dynamically. For example, if the antenna tilt is changed in a cell, it will affect the rates of call arrival and handover in this cell and the surrounding cells, and therefore the RACH load per preamble in all those cells. A change in transmission power settings or handover thresholds may have similar effects.

Whenever such a network configuration change happens, the RACH self-optimization feature should automatically make appropriate measurements of the RACH performance and usage in all the affected cells and determine any necessary updates of the RACH parameters.

RACH parameters that can then be adjusted are typically the following:
Split of RA preambles between contention-free access, contention-based access with large Msg3 (or MsgA) payload (group B preambles) and contention-based access with small Msg3 (or MsgA) payload (group A preambles);
RA back-off parameter value or the initial RACH transmission power and transmission power ramping parameters;
Any other parameter may be adjusted if found useful by network operator.

In the following, we will have a look at the signaling designed for RACH optimization over the X2 logical interface as well as the RACH UE assistance information reporting mechanism in LTE. In addition to them, we will have a look at different types of the RA procedure in NR and explain some details on how the RA procedures work.

### RACH Related Signaling Over the X2 Interface in LTE Networks

Generally, a RAN node may trigger an analysis of the information reported by one or more UEs internally or in coordination with other RAN nodes. In this regard, as a part of the LTE solution, the eNB PRACH configuration parameters can be exchanged over the X2 interface using X2AP signaling procedures involving X2 SETUP REQUEST/X2 SETUP RESPONSE message exchange and ENB CONFIGURATION UPDATE/ENB CONFIGURATION UPDATE ACKNOWLEDGE message exchange, where the PRACH Configuration IE, shown in Table 2, is contained in the Served Cell Information IE. This IE indicates the PRACH resources used in neighbor cell.

TABLE 2
PRACH Configuration IE Definitions

| | | IE type | | | |
|---|---|---|---|---|---|
| | | and | Semantics | | Assigned |
| IE/Group Name | Presence | reference | description | Criticality | Criticality |
| RootSequenceIndex | M | INTEGER | See section 5.7.2. | — | — |
| | | (0 . . . 837) | in TS 36.211 [10] | | |
| ZeroCorrelationZoneConfiguration | M | INTEGER | See section 5.7.2. | — | — |
| | | (0 . . . 15) | in TS 36.211 [10] | | |
| HighSpeedFlag | M | BOOLEAN | TRUE corresponds | — | — |
| | | | to Restricted set | | |
| | | | and FALSE to | | |
| | | | Unrestricted set. | | |
| | | | See section 5.7.2 | | |
| | | | in TS 36.211 [10] | | |
| PRACH-FrequencyOffset | M | INTEGER | See section 5.7.1 | — | — |
| | | (0 . . . 94) | of TS 36.211 [10] | | |
| PRACH-ConfigurationIndex | O | INTEGER | Mandatory for | — | — |
| | | (0 . . . 63) | TDD, shall not be | | |
| | | | present for FDD. | | |
| | | | See section 5.7.1. | | |
| | | | in TS 36.211 [10] | | |

Note that such information will be exchanged between RAN nodes with cells identified as neighboring cells. Neighboring cells would be identified by RRM measurements provided by UEs. Upon detection of a new neighbor a RAN node may request to set up an X2 interface and later update the configurations if changed. This will be accomplished as part of X2 SETUP REQUEST or ENB CONFIGURATION UPDATE X2AP signaling which includes the PRACH Configuration IF as part of the Served Cell Information IE.

In addition to the above-mentioned mechanism to exchange RCAH related configuration information over the X2 interface as part of X2 setup and eNB configuration update signaling, a Uu based signaling mechanism has been defined to use UE assistance information to detect the potential issues, and further enhance the RACH performance by performing finer optimization relying on the provided UE assistance information.

### Logging and Reporting of UE Assistance RACH Information in LTE

In LTE the report of RACH information when a random access procedure is performed may be requested by the network (i.e. the eNB) via the UEInformationRequest message in RRC (section 5.6.5 in the RRC specification for LTE, i.e. 3GPP TS 36 331) and the UE provides the requested information to the network (i.e. the eNB) in the UEInformationResponse message. In the case where a RA procedure was successful, the UE provides the RACH information in the RACH report, i.e. the RACH-Report-r16 IE (and the RACH-Report-v1610 IE), provided that the UE has stored information related to successful RA procedure(s). The UE may also include RACH information pertaining to failed RA procedures in the connection establishment failure report, i.e. the ConnEstFailReport-r11 IE), provided that the UE has stored information related to failed RA procedure(s) in conjunction with connection establishment failure(s) (wherein this information according to the modelling in the LTE RRC specification 3GPP TS 36.331 version 16.4.0 conceptually is stored in the UE variable VarConnEstFailReport).

### Logging and Reporting of UE Assistance RACH Information in NR

Similar to the procedure in LTE, an NR gNB can request a UE to report assistance/feedback information related to both successful and failed RA procedures. The requests are included in the UEInformationRequest message and the UE provides the requested information in the UEInformationResponse message, provided that the UE has stored information of the requested type(s) (which according to the modelling in the NR RRC specification 3GPP TS 38.331 version 16.4.1 conceptually is stored in the UE variables VarRA-Report, VarRLF-Report and VarConnEstFailReport).

### Synchronization Signal Block (SSB)

An important feature of NR systems is the synchronization signal block (SSB), also known as SS/PBCH block, which is periodically broadcast in every NR cell. The SSB contains signals that allows a UE to detect and synchronize with the downlink transmissions of an NR cell, as well as providing the UE with the most critical information about the system's operation and information about how to retrieve more of the critical information needed to access the cell. More specifically, the SSB consists of a primary synchronization signal (PSS), a secondary synchronization signal (SSS) and a physical broadcast channel (PBCH) transmission carrying the MIB (containing critical system information) and a few so-called PBCH payload bits (which are not part of the MIB).

In addition to enabling synchronization, the PSS+SSS also encodes the cell's physical cell identity (PCI)

Among other information, the MIB provides the search space for the PDCCH scheduling SIB1 (i.e. information telling the UE at what time and frequency resources it can find the remaining minimum system information (RMSI).)

An SSB is transmitted in 4 consecutive OFDM symbols on 240 contiguous subcarriers.

The SSBs are broadcast in bursts, where each SSB in a burst typically is transmitted with a separate beamforming configuration, e.g. a specific beam direction. Such a burst of SSB transmissions is also referred to as an SSB beam sweep, or just beam sweep. The maximum number of SSBs (and thus SSB beams), L, that may be used per burst in a cell is limited (according to the standard specifications) by the carrier frequency used in the cell. In unshared (i.e. licensed) spectrum, the following relations between carrier frequency, f, ranges and L are specified:

$$f <= 3 GHz : L = 4 \\ 3 GHz <= f <= 6 GHz : L = 8 \\ 6 GHz <= f <= 52.6 GHz : L = 64$$

The maximum L SSBs that may be broadcast in a cell are represented by candidate positions in a pattern of candidate SSB time slots, wherein the pattern depends on the subcarrier spacing. Any number of SSBs between 1 and L may be broadcast in a cell and which of the candidate SSBs that are actually transmitted, i.e. which of the candidate SSB time slots that are utilized, is indicated by the ssb-PositionsInBurst bitmap, which is a parameter included in SIB1 in the broadcast system information. Each bit in the ssb-PositionsInBurst bitmap represents a candidate SSB—or candidate SSB time slot—wherein a bit set to 1 indicates that an SSB is broadcast in the corresponding candidate SSB time slot while a bit set to 0 indicates that no SSB is broadcast in the corresponding SSB time slot.

Each candidate SSB time slot has an associated SSB index (which consequently means each bit in the ssb-PositionsInBurst bitmap can be said to be associated with an SSB index), which are numbered consecutively from 0 to L−1. In a transmitted SSB, the SSB index is indicated by the sequence of the DMRS used on the PBCH and, when L>8, three PBCH payload bits. More specifically, when L=4, the SSB index consists of 2 bits indicated by the PBCH DMRS sequence. When L=8, the SSB index consists of 3 bits indicated by the PBCH DMRS. When L−64, the SSB index consists of 6 bits, where the 3 LSBs are indicated by the PBCH DMRS sequence, while the 3 MSBs are indicated by 3 PBCH payload bits.

Irrespective of the number of SSBs in a burst (i.e. the number of SSBs in a beam sweep), each SSB burst (with up to L SSBs) is confined to a half frame, i.e. it never exceeds 5 ms in the time domain. The SSB bursts are repeated with a periodicity that ranges from 5 ms to 160 ms (the possible periodicities are 5, 10, 20, 40, 80 and 16 ms).

The SSB is one of the reference signals used for measurements, e.g. when a UE assesses the quality of a radio channel or performs RRM measurements on behalf of the network (i.e. as configured by the network).

In addition, SSB transmissions are often used as the “reference” for quasi co-location when other signals or data are transmitted. For instance, when a Random Access Response message or a MsgB is transmitted.

There currently exist certain challenges. A RACH conflict may be caused by colliding PRACH transmission resources where the same PRACH transmission resources are associated with an SSB beam in one cell and with another SSB beam in a neighbor cell, where these beams are both directed in the direction towards the other cell (i.e. the beams of the two neighbor cells essentially meet at the cell border).

### SUMMARY

A method of operating a distributed unit (DU) of a network node of a wireless communications network includes detecting a random access channel (RACH) configuration conflict for a cell served by the DU in which synchronization signal blocks (SSBs) having different SSB indices are transmitted using a plurality of spatial beams according to a beam sweeping timing, changing the beam sweeping timing of the cell from an original beam sweeping timing to a new beam sweeping timing in response to detecting the RACH conflict, and signalling the new beam sweeping timing to a control unit (CU) of the network node. Signalling the new beam sweeping timing to the CU includes signalling to the CU an indication of SSBs affected by the changing of the beam sweeping timing. Changing the beam sweeping timing includes one or more of: changing an association of one of the SSBs and one of the spatial beams, changing a beam direction index of a beam associated with at least one of the SSBs, changing a position of transmission of one of the spatial beams in an SSB burst, and/or changing a direction of one of the spatial beams carrying an associated SSB.

In some embodiments, signalling the new beam sweeping timing to the CU includes signalling an indication of a change in sweeping timing of SSBs relative to the original beam sweeping timing.

In some embodiments, changing the beam sweeping timing includes changing SSB indices of spatial beams affected by the change in beam sweeping timing.

In some embodiments, detecting the RACH configuration conflict is performed in response to information received from the CU regarding a possible RACH conflict with a neighbor cell.

In some embodiments, the information includes an indication of a RACH occasion that may be subject to a conflict and/or information about a neighbor cell RACH configuration.

In some embodiments, detecting the RACH configuration conflict is performed in response to information in a random access, RA, report and/or in response to detecting poor performance of a RA procedure.

A method of operating a control unit, CU, of a network node of a wireless communications network according to some embodiments includes receiving a message from a DU of the network node indicating a change of a beam sweeping timing of a cell served by the DU in which SSBs having different SSB indices are transmitted using a plurality of spatial beams according to a beam sweeping timing. The change of beam sweeping timing is from an original beam sweeping timing to a new beam sweeping timing, and the change of beam sweeping timing was performed in response to detecting a random access channel, RACH, configuration conflict for the cell.

The method further includes transmitting a message to a neighbor network node indicating the change of the beam sweeping timing of the cell. The message indicating the change in beam sweeping includes an indication of SSBs affected by the change in beam sweeping timing, and the change in beam sweeping timing includes one or more of: a change in an association of one of the SSBs and one of the spatial beams, a change in a direction of one of the spatial beams carrying an associated SSB, a change in a beam direction index of a beam associated with at least one of the SSBs, and/or a change in a position of transmission of one of the SSBs in an SSB burst.

The method may further include updating a beam relationship of beams used in the cell relative to beams used in a neighbor cell based on the change in beam sweeping timing

In some embodiments, the method may further include discarding existing beam relations associated with the cell.

In some embodiments, the message includes an indication of a change in sweeping timing of SSBs relative to the original beam sweeping timing.

In some embodiments, the change in beam sweeping timing includes a change in SSB indices of SSBs affected by the change in beam sweeping timing.

In some embodiments, the method may further include, prior to receiving the message from the DU, transmitting information to the DU regarding a possible RACH conflict with a neighbor cell

In some embodiments, the information includes an indication of a RACH occasion that may be subject to a conflict and/or information about a neighbor cell RACH configuration.

In some embodiments, the neighbor network node includes another CU.

A network node according to some embodiments includes processing circuitry, and power supply circuitry configured to supply power to the processing circuitry. The processing circuitry is configured to perform operations including detecting a RACH configuration conflict for a cell served by a DU of the network node in which SSBs having different SSB indices are transmitted using a plurality of spatial beams according to a beam sweeping timing, changing the beam sweeping timing of the cell from an original beam sweeping timing to a new beam sweeping timing in response to detecting the RACH conflict, and signalling the new beam sweeping timing to a CU of the network node. Signalling the new beam sweeping timing to the CU includes signalling to the CU an indication of SSBs affected by the changing of the beam sweeping timing, and changing the beam sweeping timing includes one or more of: changing an association of one of the SSBs and one of the spatial beams, changing a beam direction index of a beam associated with at least one of the SSBs, changing a position of transmission of one of the spatial beams in an SSB burst, and/or changing a direction of one of the spatial beams carrying an associated SSB.

A network node according to some embodiments is configured to perform operations including detecting a RACH configuration conflict for a cell served by a DU of the network node in which SSBs having different SSB indices are transmitted using a plurality of spatial beams according to a beam sweeping timing, changing the beam sweeping timing of the cell from an original beam sweeping timing to a new beam sweeping timing in response to detecting the RACH conflict, and signalling the new beam sweeping timing to a CU of the network node. Signalling the new beam sweeping timing to the CU includes signalling to the CU an indication of SSBs affected by the changing of the beam sweeping timing, and changing the beam sweeping timing includes one or more of: changing an association of one of the SSBs and one of the ante spatial nna beams, changing a beam direction index of a beam associated with at least one of the SSBs, changing a position of transmission of one of the spatial beams in an SSB burst, and/or changing a direction of one of the spatial beams carrying an associated SSB.

A CU of a network node according to some embodiments includes processing circuitry and power supply circuitry configured to supply power to the processing circuitry. The processing circuitry is configured to perform operations including receiving a message from a DU of the network node indicating a change of a beam sweeping timing of a cell served by the DU in which SSBs having different SSB indices are transmitted using a plurality of spatial beams according to a beam sweeping timing, and transmitting a message to a neighbor network node indicating the change of the beam sweeping timing of the cell.

The change of beam sweeping timing is from an original beam sweeping timing to a new beam sweeping timing, and the change of beam sweeping timing was performed in response to detecting a RACH configuration conflict for the cell.

The message indicating the change in beam sweeping includes an indication of SSBs affected by the change in beam sweeping timing, and the change in beam sweeping timing includes one or more of: a change in an association of one of the SSBs and one of the spatial beams, a change in a direction of one of the spatial beams carrying an associated SSB, a change in a beam direction index of a beam associated with at least one of the SSBs, and a change in a position of transmission of one of the SSBs in an SSB burst.

A CU of a network node according to some embodiments is configured to perform operations including receiving a message from a DU of the network node indicating a change of a beam sweeping timing of a cell served by the DU in which SSBs having different SSB indices are transmitted using a plurality of spatial beams according to a beam sweeping timing, and transmitting a message to a neighbor network node indicating the change of the beam sweeping timing of the cell.

Certain embodiments may provide one or more of the following technical advantages. Some embodiments described herein provide means for a gNB-DU to rearrange the beam sweep configuration of a serving cell and signal information about performed SSB beam sweep configuration changes to a gNB-CU. These means enable signaling of all allowed, relevant and useful SSB beam sweep configuration changes. The signaling means may also be used by a gNB-CU to instruct a gNB-DU to perform a certain SSB beam sweep reconfiguration operation or to let one gNB-CU inform another gNB-CU of an SSB beam sweep reconfiguration in a cell. These operations may reduce interference within a network and make procedures such as random access procedures more robust, less prone to collisions, and more efficient.

### BRIEF DESCRIPTION OF THE DRAWINGS

FIG. 1 illustrates the 5G radio access network architecture.

FIG. 2 illustrates a split architecture option in the NG-RAN architecture.

FIG. 3 illustrates a four-step RA procedure.

FIG. 4 illustrates a two-step random access procedure.

FIG. 5 illustrates a PRACH resource structure.

FIG. 6 illustrates an example in which there are two downlink beams/SSBs in a cell and both SSBs are mapped to the same PRACH occasion.

FIG. 7 illustrates the division of preambles within a PRACH occasion.

FIG. 8 illustrates SSB transmission via beams.

FIG. 9 illustrates a one-to-one SSB to PRACH occasion mapping.

FIG. 10 illustrates an SSB to PRACH occasion mapping in which the number of SSBs per RACH occasion is 2.

FIG. 11 illustrates preamble partitioning in case of shared PRACH occasions for 4-step and 2-step RA.

FIG. 12 illustrates a method by which a network node may resolve a RACH configuration conflict according to some embodiments.

FIG. 13 illustrates example operations of a second network node according to some embodiments.

FIG. 14 shows an example where two synchronized cells experience a RACH conflict for the PRACH resources associated with an SSB in cell A and B respectively.

FIG. 15 is a flowchart illustrating operations of a network node according to some embodiments.

FIG. 16 is a flowchart illustrating operations of a CU of a network node according to some embodiments.

FIG. 17 illustrates an example of a communication system in accordance with some embodiments.

FIG. 18 illustrates an example of a UE in accordance with some embodiments.

FIG. 19 illustrates an example of a network node in accordance with some embodiments.

FIG. 20 illustrates an example of a host in accordance with some embodiments.

FIG. 21 is a block diagram illustrating a virtualization environment in which functions implemented by some embodiments may be virtualized.

FIG. 22 shows a communication diagram of a host communicating via a network node with a UE over a partially wireless connection in accordance with some embodiments.

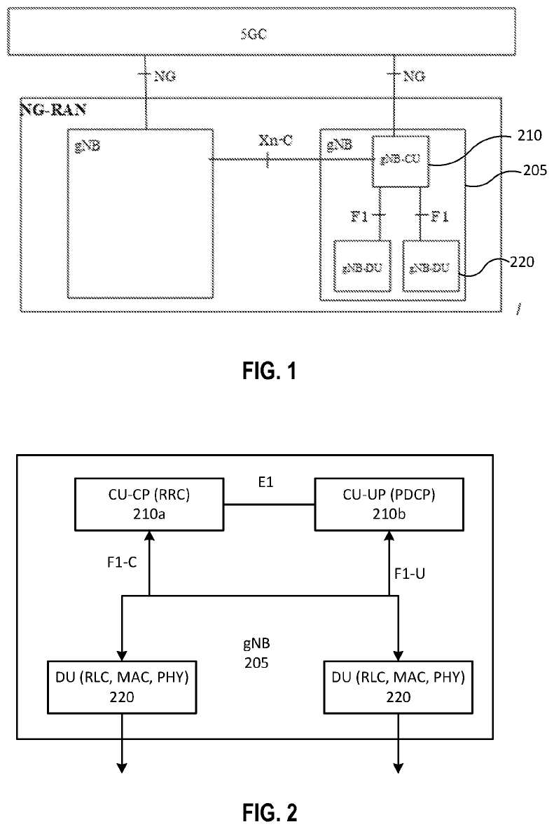

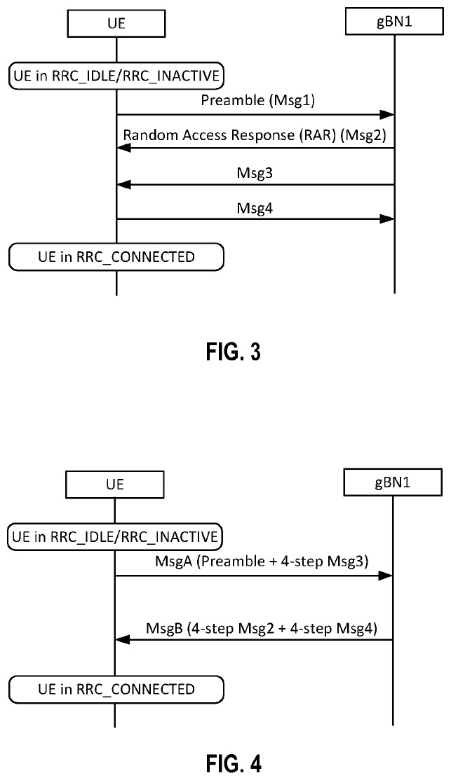

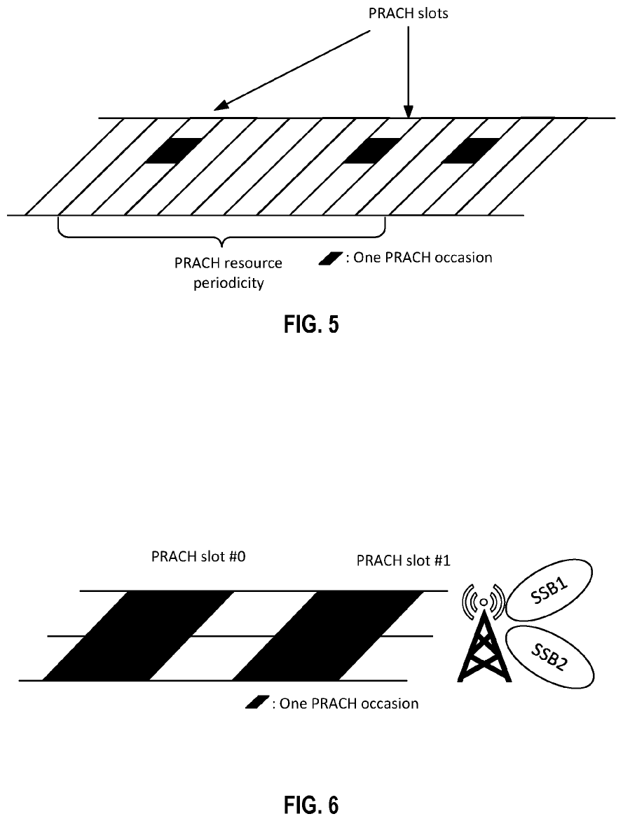

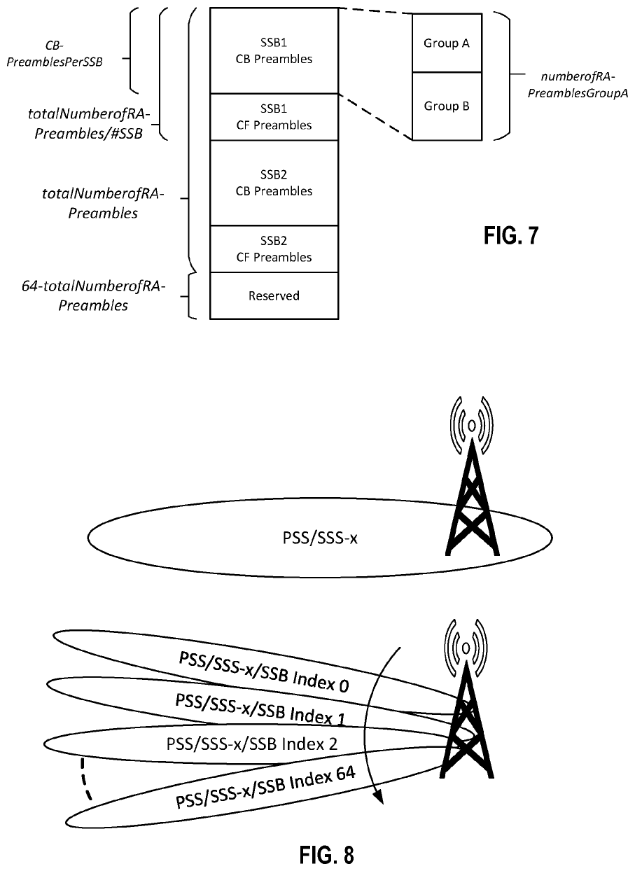

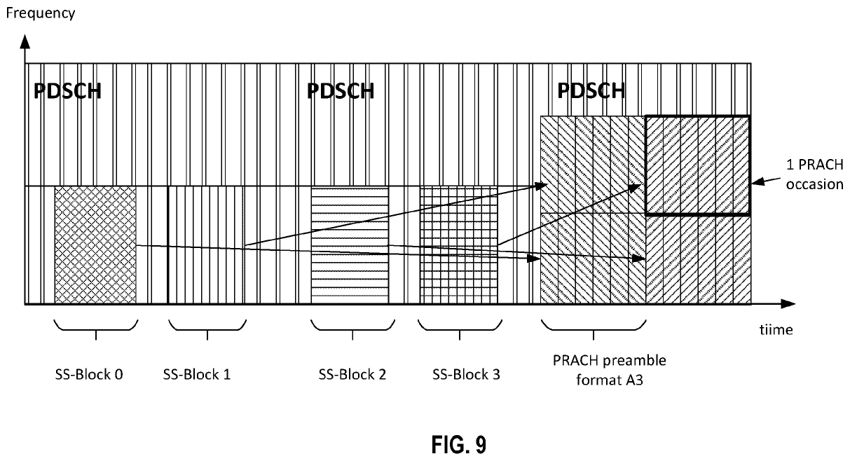

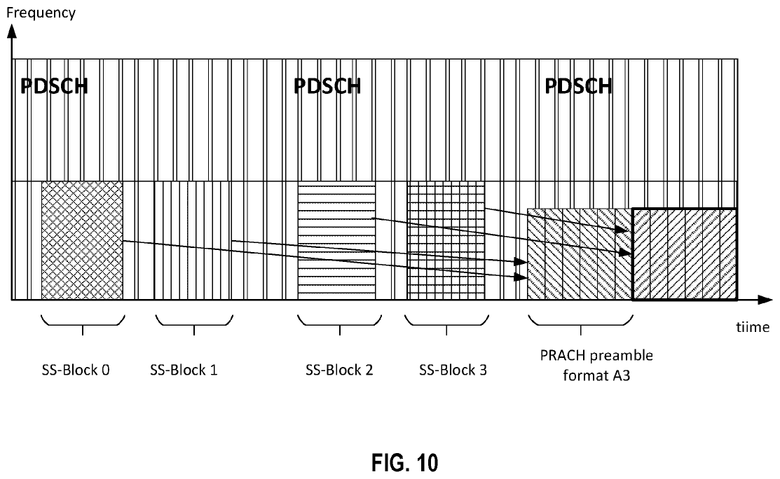

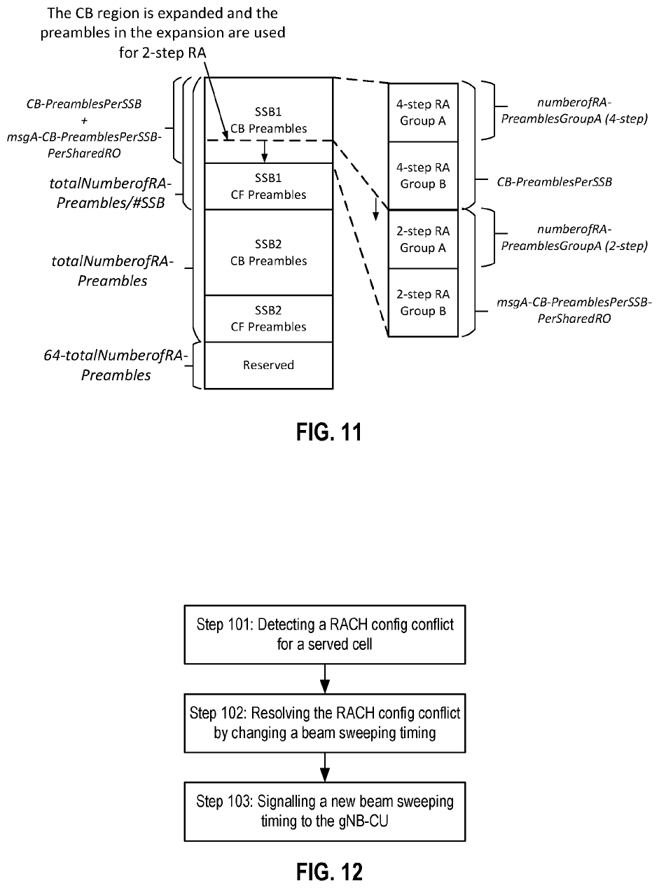

### DETAILED DESCRIPTION OF EMBODIMENTS

As noted above, a RACH conflict may be caused by colliding PRACH transmission resources where the same PRACH transmission resources are associated with a certain SSB beam in one cell and with a certain SSB beam in a neighbor cell, where these beams are both directed in the direction towards the other cell. To resolve this, the gNB-DU of the gNB in which the RACH conflict is detected may change the order in which the SSB beams are transmitted (i.e. changing the order of the SSB beam sweeping). As a result, a beam with which colliding PRACH resources were associated will be transmitted at different points in time and hence will not collide anymore.

For example, FIG. 12 illustrates a method by which a network node (e.g., a gNB-DU) may resolve a RACH configuration conflict. Referring to FIG. 12, the network node may detect a RACH configuration conflict between the RACH configuration of a served cell and the RACH configuration of a neighboring cell (step 101). In response, the network node may change the beam sweeping timing, or beam sweeping order, for the served cell based on the detection of the RACH configuration conflict (step 102). Finally, the network node may signal the new beam sweeping timing to a second network node (e.g., a gNB-CU) (step 103).

Changing the beam sweeping timing in response to detecting a RACH configuration conflict may or may not result in changing the order of SSBs transmitted in a cell (the “beam sweeping order”). For example, if the RACH configuration conflict is resolved by moving a conflicting spatial beam to another, previously unused, position in an SS burst (i.e., moving the spatial beam in the time domain), this may be done without changing the order in which the beams are transmitted, such as when the new position of the spatial beam in the SS burst may be next to the old position of the spatial beam within the burst. It will be appreciated, however, that changing the beam sweeping order necessarily entails a change in the beam sweeping timing of at least one spatial beam

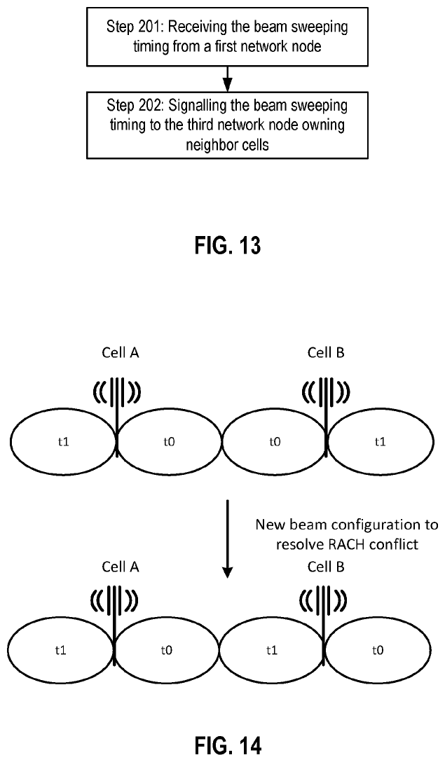

FIG. 13 illustrates example operations of a second network node. In particular, a second network node may receive a new beam sweeping timing from a first network node (e.g., from a gNB-DU over the F1 interface), upon any change of beam sweeping timing of a cell owned by the first network node (step 201) and signal the new beam sweeping timing to a third network node (e.g., another gNB-CU owning neighboring cells e.g., over Xn or NG interface or a gNB-DU connected to the second network via an F1 interface) (step 202).

The introduction of the SSB beam concept and SSB associated RACH configuration implies new requirements on the mechanisms for detection and resolution of interference/collisions between RACH occasions in neighbor cells. These concerns may be addressed through mechanisms involving changing of the beam sweeping timing to eliminate existing collisions. However, there is currently no specification for how an SSB beam sweep is actually changed in a way that is compatible with the current standard. For example, there is currently no specification for how some aspects of the relation between SSB indexes, spatial SSB beam configuration and SSB transmission time slots are changed while some aspects thereof are maintained (in order not to violate fundamental properties of the NR system). In addition, there is currently no specification for how this information is conveyed between a gNB-DU and the gNB-CU it is associated with.

Certain aspects of the disclosure and their embodiments may provide solutions to these or other challenges. In particular, some embodiments provide operations for rearrangement of a fixed set of spatial SSB beams with the purpose of resolving conflicts/collisions between neighboring cells (e.g. RACH and/or paging conflicts/collisions) as well as interference mitigation among the spatially neighboring beams. In addition, some embodiments described herein provide means for signaling such rearrangement operations between involved or affected network nodes. In one scenario, a gNB-DU uses the signaling means to inform its gNB-CU about a reconfiguration of the SSB beam sweep that the gNB-DU has performed (using one or more of the rearrangement operations) in a cell that it controls. The receiving gNB-CU may use this information, for example, to discard the existing beam relations and relearn relations (e.g. neighbor relations) involving the SSB(s) affected by the rearrangement operation. The gNB-DU may have been triggered to perform the SSB beam sweep reconfiguration by information received from the gNB-CU about detection of a possible neighbor cell conflict/collision. Such information may include, for example, an indication of RACH occasions that may be subject to conflict/collision, as well as information about neighbor cell PRACH configurations, which may allow the gNB-DU to deduce whether a beam sweep reconfiguration is an opportune solution to resolve the RACH conflict. The gNB-DU may also have been triggered to perform the SSB beam sweep reconfiguration based on its analysis on the received RA reports (i.e. feedback information about performed RA procedures received and collected from the UEs) and detected poor performance of the RA procedure based on the provided RA reports.

Some embodiments also provide signaling scenarios where the presented signaling means are used in signaling from a gNB-CU to a gNB-DU or between two gNB-CUs. A use case for the former may be that a gNB-CU has detected implications of a conflict/collision between two cells and uses the signaling means to instruct the gNB-DU serving one of the cells to change the SSB beam sweep configuration in the cell in accordance with the signaled information (e.g. including an instruction of a specific SSB beam sweep rearrangement operation) in order to resolve the conflict/collisions. Such implications of neighbor cell conflicts/collisions may, for example, come in the form of statistics of operation performance, statistics of RACH failures or other events, and/or information about possible conflicts/collisions received from another network node, such as a gNB-DU, another gNB-CU or an O&M node.

A use case for the latter, i.e. signaling between two gNB-CUs, may be, for example, that a first gNB-CU informs a second (neighbor) gNB-CU of a reconfiguration of an SSB beam sweep performed in one of the first gNB-CU's cells which is neighboring one of the cells of the second gNB-CU. In addition, the second gNB-CU, upon receiving the signal from the first gNB-CU, discards its stored information about beam sweep configuration of the reconfigured cell and relearns the new neighbor relations at cell and beam level, i.e., cell neighbor relation and beam neighbor relations. Moreover, the second gNB-CU may update the Xn interface configuration with the other RAN nodes based on the new neighbor relations learned after receiving the beam sweep reconfiguration signal from the first gNB-CU.

Accordingly, some embodiments described herein provide methods for rearranging a fixed set of spatial SSB beams in ways that serve to resolve conflicts/collisions between neighboring cells (e.g. RACH and/or paging conflicts/collisions) as well as to mitigate the interference level between neighboring cells, and in particular, means for signaling such rearrangements of spatial SSB beams from a gNB-DU to a gNB-CU, from a gNB-CU to a gNB-DU and/or from one gNB-CU to another gNB-CU

Some of the embodiments contemplated herein will now be described more fully with reference to the accompanying drawings. Embodiments are provided by way of example to convey the scope of the subject matter to those skilled in the art.

The following terms are used in the present disclosure.

Beam configuration: In this document, the term “beam configuration” refers to the set of parameters that affect the shape and direction of a beam (where the beam may be used for transmission or reception). This set of parameters may e.g. comprise antenna weights or antenna element weights.

Beamforming configuration: This term is equivalent to the term “beam configuration”.

Beam sweep: The term “beam sweep” is a common way of expressing a concept where, contrary to the intuitive interpretation of “sweep”, no beam is actually moving continuously in the way the word “sweep” implies. Instead a series of discrete beams are transmitted one at a time in a sequential fashion, either contiguously in the time domain or with time gap between two successive beams. Each of the beams in such a, beam sweep has a beamforming configuration (e.g. in terms of antenna weights or antenna element weights) that is unique among the beams in the beam sweep, i.e. each beam in the beam sweep has its own direction and/or spatial shape (and this its own coverage area). Typically, successive beams in a beam sweep are partly spatially overlapping, so that the beams in the beam sweep together cover an intended area, e.g. a cell. When beam sweeping is applied to transmissions, this may be referred to as transmit (TX) beamforming. Beam sweeping can also be applied on the receiver side (i.e. RX beam sweeping). In this case, the receiver tries multiple receive (RX) beams, wherein each RX beam has its own beamforming configuration (e.g. in terms of antenna weights or antenna element weights), e.g. to find out which RX beam that provides the reception quality. RX beamforming may be either analog or digital (or a hybrid of the two). With analog beamforming, the receiver can only receive a transmission with one RX beam at a time. Consequently, to try multiple RX beams (e.g. N RX beams) in an RX beam sweep, the transmission the receiver receives has to be repeated multiple times (e.g. N times), so that the receiver can try reception with all the intended RX beams. With digital RX beamforming, the receiver can receive a transmission with all RX beams simultaneously. In practice this means that the receiver receives the transmission with all antennas or antenna elements and subsequently applies different antenna weights or antenna element weights (matching different RX beams) to the received transmission during digital postprocessing. When “beam sweeping” is referred to without TX/RX specification, this typically refers to TX beam sweeping.

Beam sweep configuration: This term refers to the configuration of an entire beam sweep, which includes the number of beams, the spatial shape and direction (i.e. the beam configuration/beamforming configuration) of each beam, as well as the time of transmission (in case of a TX beam sweep) of each beam (which implicitly provides the order of transmission of the beams and the beam index) in the beam sweep. The beam sweeps subject to such configuration are SSB beam sweeps (also referred to as SS/PBCH block beam sweeps), wherein an SSB beam sweep (or SS/PBCH block beam sweep) constitutes an SS burst (herein also referred to as an SS/PBCH burst), wherein such a beam sweep or burst includes a set of SSB(s) (or SS/PBCH block(s)) transmitted in an order with increasing associated SSB indexes (or SS/PBCH block indexes).

PRACH occasion: A set of time/frequency transmission resources in the OFDM time/frequency grid that a UE can use to transmit a random access preamble. If a PRACH occasion is defined by its slot number, set of symbol numbers within the slot and set of subcarriers (or PRBs) in the frequency domain, then each PRACH occasion is unique within its PRACH configuration period. However, a PRACH occasion with the same defining properties/parameters will recur in each PRACH configuration period. If the SSB index(es) that map(s) to the PRACH occasion is added to its defining properties/parameters, then each PRACH occasion is unique within its association period, but a PRACH occasion with the same defining properties/parameters will recur in each association period.

PRACH resource: A set of time/frequency transmission resources in the OFDM time/frequency grid, where this set of time/frequency transmission resources constitute one PRACH occasion.

PRACH resources: Multiple sets of time/frequency transmission resources in the OFDM time/frequency grid, wherein each set of time/frequency transmission resources constitute one PRACH occasion.

RACH occasion (RO): This term is equivalent to the term “PRACH occasion”.

RACH resource: This term can be used as equivalent to PRACH resource, but it may also be used to refer to random access preambles or random access preamble ranges or both a PRACH resource and associated random access preambles/random access preamble ranges.

RACH resources: This term can be used as equivalent to PRACH resources, but it may also be used to refer to random access preambles or random access preamble ranges or both PRACH resources and associated random access preambles/random access preamble ranges.

Spatial beam: In this document, the term “spatial beam” refers to a beam's beamforming configuration, or the beam resulting from a beamforming configuration. A spatial beam may also be referred to as an “antenna beam,” “spatial SSB beam,” or the like.

The terms/names/abbreviations “CU”, “DU”, “CU-CP” and “CU-UP” are equivalent to the respective terms/names/abbreviations “gNB-CU”, “gNB-DU”, “gNB-CU-CP” and “gNB-CU-UP”.

The term “beam direction” is frequently used herein as equivalent to “spatial beam”, which refers to the beam's beamforming configuration.

The expression “SSB X” (e.g. “SSB 1”) refers to an SSB with SSB index X (e.g. SSB index 1).

The term “time slot” (or “SSB time slot”) is frequently used in this solution description to refer to 4 consecutive OFDM symbols that may be used to transmit an SSB. This can be seen as equivalent to the term “candidate SSB position”. It should not be confused with the meaning of the term “slot” in NR (i.e. 14 OFDM symbols with normal cyclic prefix or 12 OFDM symbols with extended cyclic prefix) and LTE (i.e. 7 OFDM symbols with normal cyclic prefix or 12 OFDM symbols with extended cyclic prefix) respectively.

In some information element (IE) examples in the solution description, the term “(re) configuration” is used as a convenient abbreviated notation instead of the wording “configuration or reconfiguration” which may be more appropriate in a parameter/IE name in a technical specification, such as 3GPP TS 38.473 or 3GPP TS 38.423.

The transmission of a random access preamble, or random access preamble transmission, can be considered equivalent to the term PRACH transmission (since the random access preamble is transmitted on the Physical Random Access Channel, PRACH).

In the context of this disclosure, the term “preamble” is often used as short for “random access preamble”.

The network nodes involved in the embodiments described herein are referred to as gNB, gNB-CU and gNB-DU. However, some embodiments are also applicable in systems where these network nodes are replaced by other types of network nodes. For example, gNB may be replaced by eNB, gNB-CU man be replaced by eNB-CU, and/or gNB-DU may be replaced by eNB-DU. In addition, a gNB-CU may be “represented” by a gNB-CU-CP and/or an eNB-CU may be “represented” by an eNB-CU-CP.

The following discussion will describe what changes of the SSB beam sweep configuration that a gNB-DU can reasonably perform to reduce or eliminate RACH conflicts with neighbor cells, as well as provide means for signaling of information to the gNB-CU to describe the change(s). In one scenario, a gNB-CU may have detected, or received information about, a possible/potential RACH conflict (or other conflicts/collisions, such as paging collisions) between one of the gNB-DU's cell(s) and a neighbor cell, and may then request the gNB-DU to perform suitable actions to resolve the conflict/collision. Such a request from the gNB-CU to the gNB-DU may include e.g. an indication of RACH occasions that may be subject to conflict/collision. In addition, other signaling scenarios involving the transfer of SSB beam sweep reconfiguration information between network nodes, using the proposed signaling means are also described. In another approach, the gNB-CU provides assistance information to enable the gNB-DU to detect the conflict with the neighboring cells. Such information which may be basis for changing beam sweep configuration and arrangement can be e.g. RACH reports fetched from the UEs or the PRACH configuration of the neighboring cells associated with the information of the in-conflict serving cell.

The signaling of SSB beams sweep reconfiguration information from a gNB-DU to a gNB-CU may advantageously be incorporated in F1AP (i.e. the signaling protocol used between a gNB-CU and a gNB-DU), either utilizing newly introduced message(s) for this purpose or utilizing existing message(s), such as the GNB-DU CONFIGURATION UPDATE and GNB-DU CONFIGURATION UPDATE ACKNOWLEDGE messages, extended with the new IE(s). Similarly, information about a possible neighbor cell conflict/collision may also utilize F1AP, either utilizing newly introduced message(s) for this purpose or utilizing existing message(s), such as the ACCESS AND MOBILITY INDICATION message, possibly extended with additional parameter(s)/IE(s).

Some embodiments may be applicable for resolution of a variety of conflicts/collisions between neighbor cells, e.g. resulting from poor, unsuccessful or non-existent coordination of various uplink and downlink transmission resource allocation for various purpose. However, some embodiments presented herein focus on RACH conflicts/collisions between neighbor cells as a main scenario, although it can be beneficial for interference mitigation among the neighboring cells as well. A RACH conflict/collision arises because the same PRACH resources (and preamble range) are used simultaneously (or with overlapping RACH occasion durations) in two neighbor cells, in particular when they are used in beam directions that make the areas where they are used neighbor or even overlap with each other. That is, the usage of the same PRACH resources coincide both temporally and spatially (and in frequency).

A reasonable assumption is also that when the cell is deployed, a set of spatial beams is selected for suitable coverage of the cell area. There may be an initial phase of tuning until you get a cell coverage you are happy with, but after that we regard this set of spatial beams as something we don't want to change. These spatial beams are maybe not written in stone, but we won't change them unless the radio environment changes, e.g. due to new neighbor cells being deployed, which is an exceptional event. We thus have a fixed set of spatial beams, where each beam's spatial configuration parameters (antenna weights resulting in direction, width, etc.) are fixed. For simplicity, we may refer to this as a set of beam directions, or a set of spatial beams.

In such a scenario, eliminating a RACH conflict by removing a certain area, or spot, from the cell's intended coverage area is not an attractive solution, since it may create coverage holes and decrease the level of service provided by the network. Instead, the beam covering the problematic area should be transmitted at another time, so that it no longer coincides with the concerned beam in the neighbor cell. Hence, to eliminate a detected RACH conflict/collision, a gNB-DU can change the order in which the spatial SSB beams are transmitted, e.g. so that the order in which the different beam directions are covered is changed. The beam directions remain the same, but the time a beam is transmitted in a certain direction is changed. This may be done in different ways and in general we may refer to this as changing the SSB beam sweep configuration or changing the beam sweep configuration.

When it comes to SSB beam sweep reconfiguration, it is important to understand the rules and limitations governing an SSB beam sweep, in particular with regards to the SSB index.

As indicated above, an SSB index is tied to a candidate SSB position in a pre-defined SSB burst pattern in the time domain. The SSB index thus conveys timing information to a UE that receives it. As also described above, each bit in the ssb-PositionsInBurst bitmap is tied to one of the candidate SSB positions. For instance, if a 4 bits long ssb-PositionsInBurst bitmap (i.e. L=4) is set to 1111, this means that all possible SSBs are transmitted and they are transmitted in the SSB index order 0, 1, 2, 3. If the gNB is configured to transmit less than the maximum number of SSBs in a cell, e.g. 2 SSBs, there is a choice of which candidate SSB positions to utilize. As one example, the ssb-PositionsInBurst bitmap may be set to 1100, indicating that SSBs are transmitted in the first two candidate SSB positions with SSB indexes 0 and 1 (transmitted in that order). As another example, the ssb-PositionsInBurst bitmap may be set to 0101, indicating that SSBs are transmitted in the second and fourth of the candidate SSB positions with SSB indexes 1 and 3 (transmitted in that order with an unutilized candidate SSB position in between).

So, the transmission order of SSB indexes, as well as the point in time when each SSB index is transmitted (if it is transmitted at all) in an SSB burst cannot be rearranged, because these properties are fixed by specification What is not specified, however, is the beamforming configuration (e.g. antenna weights or antenna element weights), e.g. the beam direction, of each SSB beam. This is hence a degree of freedom that can be utilized when reconfiguring an SSB beam sweep to eliminate a RACH conflict (e.g. a RACH occasion collision between two neighboring cells). Another degree of freedom that can be utilized is that if less than the maximum number of SSBs are broadcast in a cell, an SSB beam causing a RACH conflict may be moved in the SSB pattern so that it utilizes a previously unutilized candidate SSB position.

Note that changing of the SSB beams' beamforming configurations (indicated as the first degree of freedom above) may be done in different ways. One way is to target the size of each SSB beam's footprint, e.g. making some SSB beams wider and some narrower. Another way is to change the number of SSB beams in the SSB burst, e.g. making them fewer, which means that each SSB beam (at least on average) has to become wider, or increasing the number, which means that each SSB beam (at least on average) should become narrower. A third possibility is to rearrange, e.g. shuffle around, the existing set of spatial SSB beams, so that the order in which certain beam directions are transmitted in is rearranged, i.e. changing the order in which certain segments of the cell are covered. This is to keep the coverage area of the cell unchanged before and after the rearrangement. In this third example, it is assumed that the cell is configured with a certain set of spatial SSB beams (i.e. each with a certain configuration of antenna weights or antenna element weights) and the order of these spatial beams can be changed, but disregarding their transmission order the set of spatial SSB beams remains unchanged. The last example has an advantage over the two first examples when it comes to signaling information describing the change. The last example, where spatial beams with fixed beamforming configurations are rearranged is much simpler to describe, as it only concerns describing how the fixed beams have been moved around among the candidate SSB positions, whereas the first two examples (also) requires that information about each SSB beams particular beamforming configuration (e.g. antenna weights or antenna element weights) are conveyed. In addition, information describing rearranging of previously existing spatial SSB beams among the candidate SSB positions is much easier for the receiver of the signaling, e.g. a gNB-CU to determine/estimate the consequences of and thus to utilize for determining possible appropriate actions.

Rearranging of an existing set of spatial SSB beams among the candidate SSB positions (which may include making use of a previously unutilized candidate SSB position) is therefore the type of SSB beam sweep reconfiguration that is the main focus in the herein described solution. Note that changing the candidate SSB position a certain spatial SSB beam is transmitted in is equivalent to changing the timing (i.e. the time of transmission) of the spatial SSB beam. To again emphasize what has previously been described, when a spatial SSB beam is moved from one candidate SSB position to another, the SSB index conveyed by the spatial beam must also change accordingly.

### Primary Embodiments

In some embodiments, if a gNB-DU has changed the SSB sweep configuration, e.g. as a reaction to a (potential) RACH conflict/collision problem indicated by the gNB-CU or detected by the gNB-DU itself, and wants to inform the gNB-CU about the change, a very basic rudimentary level of information could be that the gNB-DU simply informs the gNB-CU that the SSB sweep configuration has changed without any details whatsoever about the nature of the change. Even this very coarse and rudimentary information may be useful for the gNB-CU, which for instance, upon reception of the indication of SSB beam sweep reconfiguration, may decide to discard any learned relationship between SSB beams in the concerned cell and SSB beams in neighbor cells (where such relationships e.g. may be acquired aided by UE assistance, e.g. based on measurement reports or ANR reports from UEs). The gNB-CU may then restart this learning process from scratch for the concerned cell. To this end, by means of UE measurements taken on serving and neighbor cells, the gNB-CU may relearn the neighbor associations between the new gNB-DU beam configuration and neighbor cell beams.

As a next higher level of information (i.e. richer information) the gNB-DU could signal to its gNB-CU, the information about the SSB beam sweep reconfiguration could include indications of the affected SSBs (e.g. the SSB indexes of the SSB beams affected by the change). For instance, if the spatial SSB beams associated with SSB index 1 and 3 have been swapped, the gNB-DU could signal to the gNB-CU that SSB indexes 1 and 3 are affected. The gNB-CU could then, as one possible action, determine to discard any learned relationship involving the SSBs with SSB index 1 and 3 (and base new detected relationships for these SSBs only on subsequently acquired new information). Since the overall coverage remains unchanged, the gNB-CU may now (after the SSB beam sweep configuration has been changed) limit its (initial) actions to associating the neighbor beams of SSB 1 to the SSB 3 and the neighbor beams of SSB 3 to the SSB 1. The gNB-CU can of course corroborate the new beam relations using further RRM measurements. This change in the beam relations (not requiring relearning of SSB beam relations) would avoid a glitch in procedures that require SSB beam relations, such as handover procedures.

Some embodiments allow the gNB-DU to change the SSB beam sweep to avoid PRACH collisions and then inform the gNB-CU so that it can take consequent actions e.g., updating the SSB beam relations with the neighboring cells. One way of changing the timing of the fixed set of spatial beams (so that spatially colliding PRACH resources no longer coincide in time) is to swap the time slots of two spatial beam directions or to involve more than two beam directions and let them take each other's respective time slots in a sequential change (e.g. such that SSB 0 takes the direction of SSB 2, SSB 2 takes the direction of SSB 1 and SSB 1 takes the direction of SSB 0). (Note that the term “time slot” is used here in a generic sense (not to be confused with the meaning of the term “slot” and NR and LTE respectively) and in the context of SSB transmission, a time slot could be seen as the time period occupied by the four symbols when the SSB is transmitted.)

As an example, if SSB O has a problem, e.g. that its associated RACH occasions collide with RACH occasions associated with SSB X in a neighbor cell, then the gNB-DU can change the direction (i.e. change the spatial beamforming configuration) of SSB 0, but to ensure that the cell is still covered according to the beam sweep coverage plan, the gNB-DU may swap the beam direction (i.e. the spatial beam) of SSB 0 with the beam direction (i.e. the spatial beam) of another SSB, e.g. SSB 2. So, after this swap, SSB 0 will be transmitted in the direction SSB 2 used to have and SSB 2 is transmitted in the direction SSB 0 used to have. The order of transmission of beam indexes is still the same, while the order in which the SSBs spatially covers the cell area has changed. This means that the PRACH resources associated with SSB 0 will no longer spatially collide with the PRACH resources associated with SSB X of the neighbor cells, since now the direction in which the PRACH resources of SSB 0 are used is now changed (and the UEs using those PRACH resources will be located in another part of the cell). And the PRACH resources associated with SSB 2 will not collide with the PRACH resources of SSB X in the neighbor cell either, since they do not coincide in time.

So, if the gNB-DU for example swaps the directions (but not the timing) of SSB 0 and SSB 2, then the gNB-DU can inform the gNB-CU that SSB 0 and SSB 2 are affected by a beam sweep change. The gNB-CU then knows that any beam relation or neighbor relations it has learned involving SSB 0 or SSB 2 is no longer valid and can be discarded. The gNB-CU instead has to learn new relations involving SSB 0 and SSB 2 and may also initiate actions to speed up this learning procedures, e.g. using beam level RRM reporting or ANR procedures. In another approach, since the cell coverage, i.e. the compound coverage of all the SSB beams, is not changed and the involved SSB beams are only spatially changed, beam relations can be updated by associating the previous SSB 0 neighbor beams (neighbor before the changing the SSB beam sweep configuration i.e., changing SSB beam direction) with SSB 2 and, associating previous SSB 2 neighbor beams with SSB 0 (i.e., the beam neighbor relations for SSB 0 and SSB 2 are swapped). Note that since SSB 0 and SSB 2 area transmitted at different times (where this transmission times remains the same after the swap), swapping of beam neighbor relations in this way will still serve to resolve potential RACH conflicts involving RACH occasions associated with SSB 0 and/or SSB 2.

As a next level above just informing the gNB-CU of the impacted SSBs, the gNB-DU could indicate in which way the SSB beam directions have been reshuffled, e.g. in this example where SSB 0 is transmitted in the old direction of SSB 2 and vice versa. This could be captured in Table 3, which could be transformed into a parameter structure for signaling.

TABLE 3
New SSB Beam Sweep Configuration

| | The impacted SSB's beam direction in the new SSB |
|---|---|
| Impacted | beam sweep configuration expressed in terms of a beam |
| SSB | direction in the old SSB beam sweep configuration |
| SSB 0 | SSB 2 |
| SSB 2 | SSB 0 |

Table 3 says that SSB 0 is impacted and now (after the SSB beam sweep reconfiguration) has the beam direction that SSB 2 used to have (before the SSB beam sweep reconfiguration). Table 3 also says that SSB 2 is impacted and now has the beam direction that SSB 0 used to have (i.e. the directions of SSB 0 and SSB 2 have been swapped).

But we are not limited to swapping spatial beam directions. For instance, a gNB-DU could also shift the SSB's directions in a sequence, e.g. SSB 0 takes the direction of SSB 1, SSB 1 takes the direction of SSB 2 and SSB 2 takes the direction of SSB 0. In Table 4, this is captured as follows (which could be converted into a parameter structure for signaling).

TABLE 4
New SSB Beam Sweep Configuration

| | The impacted SSB's beam direction in the new SSB |
|---|---|
| Impacted | beam sweep configuration expressed in terms of a beam |
| SSB | direction in the old SSB beam sweep configuration |
| SSB 0 | SSB 1 |
| SSB 1 | SSB 2 |
| SSB 2 | SSB 0 |

Another rearranging operation a gNB-DU could perform is to change which candidate SSB positions (i.e. SSB indexes) that are used. As an example, the first two out of four candidate SSB positions are used (i.e. ssb-PositionsInBurst=1100). Then the gNB-DU wants to change the timing of the spatial beam of SSB 1, but not its beam direction, e.g. so that it instead is transmitted in the third candidate SSB position (i.e., differently expressed, in the third time slot), which consequently would mean that its SSB index is changed from 1 to 2, resulting in the new ssb-PositionsInBurst=1010. This example is illustrated in Table 5, which is extended with another column, as shown.

TABLE 5
New SSB Beam Sweep Configuration with New SSB Index

| Im- | New | The impacted SSB's beam direction in the new SSB |
|---|---|---|
| pacted | SSB | beam sweep configuration expressed in terms of a beam |
| SSB | index | direction in the old SSB beam sweep configuration |
| SSB 1 | 2 | SSB 1 |

Again, the values in Table 5 could be transformed into a parameter structure which is conveyed from the gNB-DU to the gNB-CU. From this information, the gNB-CU can deduce that the old SSB 1 has the new SSB index 2 (and thus that the new ssb-PositionsInBurst=1010), but has retained its old spatial beam direction.

A gNB-DU may also combine change of candidate SSB position (and thus SSB index) and change of spatial beam direction. Such a combination means that the SSB receiving the new index also takes the direction of another SSB and this other SSB will also have to get a new direction. For simplicity, we can make it a swap in this example. So an example scenario could be that we have ssb-PositionsInBurst=1100 and then we want to change the timing of SSB 1 by moving it to the third position and we thus get the new ssb-PositionsInBurst=1010 and hence the old SSB 1 gets a new index and becomes SSB 2. Now let's also swap the beam directions between the new SSB 2 (i.e. the old SSB 1) and SSB 0. This is not visible in the ssb-PositionsInBurst bitmap, but nevertheless, it has a significant impact on the beam relations. This combined operation can be captured as follows in Table 6 (which may be converted into a parameter structure which is signaled from the gNB-DU to the gNB-CU).

TABLE 6
New SSB Beam Sweep Configuration with New SSB Index

| Im- | New | The impacted SSB's beam direction in the new SSB |
|---|---|---|
| pacted | SSB | beam sweep configuration expressed in terms of a beam |
| SSB | index | direction in the old SSB beam sweep configuration |
| SSB 0 | 0 | SSB 1 |
| SSB 1 | 2 | SSB 0 |

From the information in Table 6, the gNB-CU can deduce that the new ssb-PositionsInBurst=1010 and also that SSB 0 and the new SSB 2 (i.e. the old SSB 1) have swapped beam directions.

The first two example cases above (Tables 3 and 4), i.e. swapping of spatial beams and sequential changes/shifting of spatial beams, were captured in a type of table consisting of two columns. The subsequent third and fourth example cases (Tables 5 and 6) required an additional column and were captured in type of table containing three columns, i.e. an extended version of the two-column table type. The table type with three columns is general enough to capture all four example cases, even though one of the columns will be redundant for the two first example cases (i.e. for swapping of spatial beam and sequential changes/shifting of spatial beams).

These four example cases with the extended table type are illustrated in Tables 7 to 10.

TABLE 7
Swapping the beam directions of SSB 0 and
SSB 2 (ssb-PositionsInBurst unchanged)

| Im- | New | The impacted SSB's beam direction in the new SSB |
|---|---|---|
| pacted | SSB | beam sweep configuration expressed in terms of a beam |
| SSB | index | direction in the old SSB beam sweep configuration |
| SSB 0 | 0 | SSB 2 |
| SSB 2 | 2 | SSB 0 |

TABLE 8
Sequential SSB beam direction change/shift SSB 0 → SSB 1 →
SSB 2 → SSB 0 (ssb-PositionsInBurst unchanged)

| Im- | New | The impacted SSB's beam direction in the new SSB |
|---|---|---|
| pacted | SSB | beam sweep configuration expressed in terms of a beam |
| SSB | index | direction in the old SSB beam sweep configuration |
| SSB 0 | 0 | SSB 1 |
| SSB 1 | 1 | SSB 2 |
| SSB 2 | 2 | SSB 0 |

TABLE 9
Change of SSB index (and thus timing) with retained
beam direction (SSB 1 gets index 2, ssb-PositionsInBurst
changed from 1100 to 1010)

| Im- | New | The impacted SSB's beam direction in the new SSB |
|---|---|---|
| pacted | SSB | beam sweep configuration expressed in terms of a beam |
| SSB | index | direction in the old SSB beam sweep configuration |
| SSB 1 | 2 | SSB 1 |

TABLE 10
Change of SSB index combined with beam direction swap
(SSB 1 gets index 2 and the beam direction of SSB
0, SSB 0 gets the beam direction of the old SSB 1,
ssb-PositionsInBurst changed from 1100 to 1010)

| Im- | New | The impacted SSB's beam direction in the new SSB |
|---|---|---|
| pacted | SSB | beam sweep configuration expressed in terms of a beam |
| SSB | index | direction in the old SSB beam sweep configuration |
| SSB 0 | 0 | SSB 1 |
| SSB 1 | 2 | SSB 0 |

Such a table can thus capture a variety of SSB beam direction and candidate SSB position reshuffling and it would be easy to transform the table into a parameter structure, e.g. as a list of triplets (wherein each triplet would represent a table row) or, alternatively, three consistently ordered lists (wherein each list would represent a table column).

FIG. 14 shows an example where two synchronized cells, A and B, experience a RACH conflict for the PRACH resources associated with SSB 0 (transmitted at time t0) in cell A and B respectively. The figure shows how this conflict can be eliminated by swapping the spatial direction of SSB 0 (transmitted at time t0) and SSB 1 (transmitted at time t1) in cell B.

Table 11 is an example of how the type of table presented above can be captured in IE specifications, e.g. in 3GPP TS 38.473, using a list of triplets.

TABLE 11
Example IE Specification

| | | | | |
|---|---|---|---|---|
| | | | IE type and | Semantics |
| IE/Group Name | Presence | Range | reference | description |

| | | | |
|---|---|---|---|
| SS-PBCH burst | | | |
| reconfiguration | | | |
| >Impacted SS-PBCH | | 1 . . . <maxnoof | |
| blocks | | SS-PBCH-Blocks> | |
| >>Impacted SS-PBCH | M | | INTEGER |
| block index | | | (0 . . . 63, . . .) |
| >>New SS-PBCH block | O | | INTEGER |
| index | | | (0 . . . 63, . . .) |
| >>Old SS-PBCH block | O | | INTEGER |
| index of the beam | | | (0 . . . 63, . . .) |
| direction | | | |

Note that if the optional parameters are omitted in the above IE example, the remaining information is the rudimentary SSB beam sweep reconfiguration information that only indicates the SSB indexes of the SSBs impacted by the reconfiguration.

In another IE specification example shown in Table 12 below, the type of table presented above is captured using three correspondingly ordered parameter lists.

TABLE 12
Example IE Specification

| | | | IE type and | |
|---|---|---|---|---|
| IE/Group Name | Presence | Range | reference | Semantics description |
| SS-PBCH burst | | | | |
| reconfiguration | | | | |
| >Impacted SS-PBCH | | 1 . . . <maxnoof | | |
| blocks | | SS-PBCH-Blocks> | | |
| >>Impacted SS-PBCH | M | | INTEGER | |
| block index | | | (0 . . . 63, . . .) | |
| >New SS-PBCH block | | 1 . . . <maxnoof | | If this list is |
| indexes | | SS-PBCH-Blocks> | | included/present, it must |
| | | | | have the same number of |
| | | | | items as the “Impacted |
| | | | | SS-PBCH blocks” list. |
| | | | | The first item in the list |
| | | | | corresponds to the first |
| | | | | item in the “Impacted SS- |
| | | | | PBCH blocks” list. The |
| | | | | second item in the list |
| | | | | corresponds to the |
| | | | | second item in the |
| | | | | “Impacted SS-PBCH |
| | | | | blocks” list, etc. |
| >>New SS-PBCH block | O | | INTEGER | This IE represents the |
| index | | | (0 . . . 63, . . .) | new SS-PBCH block |
| | | | | index replacing the |
| | | | | corresponding Impacted |
| | | | | SS-PBCH block index IE, |
| | | | | in the case where the |
| | | | | spatial beam has been |
| | | | | moved from one |
| | | | | candidate SS-PBCH |
| | | | | block position (with one |
| | | | | SS-PBCH block index) to |
| | | | | another candidate SS- |
| | | | | PBCH block position (with |
| | | | | another SS-PBCH block |
| | | | | index). |
| >Old SS-PBCH block | | 1 . . . <maxnoof | | If this list is |
| indexes of beam directions | | SS-PBCH-Blocks> | | included/present, it must |
| | | | | have the same number of |
| | | | | items as the “Impacted |
| | | | | SS-PBCH blocks” list. |
| | | | | The first item in the list |
| | | | | corresponds to the first |
| | | | | item in the “Impacted SS- |
| | | | | PBCH blocks” list. The |
| | | | | second item in the list |
| | | | | corresponds to the |
| | | | | second item in the |
| | | | | “Impacted SS-PBCH |
| | | | | blocks” list, etc. |
| >>Old SS-PBCH block | O | | INTEGER | This IE indicates the |
| index of the beam | | | (0 . . . 63, . . .) | beam direction of the SS- |
| direction | | | | PBCH block with the |
| | | | | index indicated by the |
| | | | | corresponding Impacted |
| | | | | SS-PBCH block index IE |
| | | | | or, if present, the New |
| | | | | SS-PBCH block index IE, |
| | | | | expressed in terms of the |
| | | | | direction of an SS-PBCH |
| | | | | block beam in the SS- |
| | | | | PBCH block beam sweep |
| | | | | configuration before the |
| | | | | SS-PBCH block beam |
| | | | | sweep configuration |
| | | | | update. |

Note that if the optional parameters are omitted in the IE example in Table 12, the remaining information is the rudimentary SSB beam sweep reconfiguration information that only indicates the SSB indexes of the SSBs impacted by the reconfiguration.

As mentioned above, the focus of the embodiments and example cases described above has been on SSB beam sweep reconfigurations involving rearrangement of a set of fixed spatial beams, while other types of beam sweep reconfigurations, e.g. involving changing of the spatial beamforming configuration (e.g. changing of antenna weights or antenna element weights) of one or more beams, with or without changing of the number of beams in the burst/sweep, have been excluded from the main focus. The motivation has been that it would be complicated, or require significant amounts of data, to describe such reconfigurations using signaling parameters, and also that it would be more difficult for the receiving gNB-CU to base appropriate actions on such information.

However, a framework for supporting signaling of SSB beam sweep reconfigurations should have at least some rudimentary support for all types of SSB beam sweep reconfigurations. For instance, the gNB-DU could have the possibility to signal an indication to the gNB-CU indicating that an SSB beam sweep reconfiguration has been performed, which cannot be described with the available signaling parameters. The interpretation of the indication could thus essentially be e.g.: “Completely remade beam sweep, forget everything you knew before”. This indication should preferably be complemented by the new ssb-PositionsInBurst Optionally, this simple indication could be used regardless of the nature of the SSB beam sweep reconfiguration, i.e. even for the SSB reconfiguration cases described above.

### Additional Embodiments Using Beam Direction Indexes

In the embodiments in this section, the concept of a beam direction index is introduced. A beam direction index is an index associated with a certain beamforming configuration (e.g. a set of antenna weights or antenna element weights). In other words, it is associated with a spatial beam and equivalent terms could be spatial beam index, beamforming configuration index, or beam configuration index. A set of beamforming configurations, which, when used, forms a set of spatial beams, e.g. a set of SSB beams in a burst of SSB beams forming an SSB beam sweep, can thus be associated with a set of beam direction indexes (or, equivalently, a set of spatial beam indexes).

Like the embodiments above, the embodiments in this section focus on beam sweep reconfigurations involving rearrangement of a set of fixed spatial beams. To support these embodiments, the notion of a beam direction index, or a spatial beam index, is introduced, such that every SSB beam in an SSB beam sweep is associated with a beam direction index. The way these indexes are used is that first a “reference SSB beam sweep configuration” is established and in this reference SSB beam sweep configuration, the SSBs are associated with beam direction indexes, e.g. in sequential order. That is, if contiguous SSB indexes are used (i.e. the SSBs are transmitted in contiguous candidate SSB positions), SSB 0 is associated with beam direction index 0, SSB 1 is associated with beam direction index 1, etc. If non-contiguous SSB indexes are used (i.e. the SSBs are transmitted in non-contiguous candidate SSB positions), e.g. using every second SSB index (e.g. SSB 0, SSB 2, SSB 4 . . . ), the beam direction indexes assigned in the reference SSB beam sweep configuration may still have the same values as SSB index of the associated SSB (e.g. beam direction indexes 0, 2, 4 . . . ), but another option is the beam direction indexes are assigned in a contiguous sequential series, e.g. the SSB 0 gets beam direction index 0, SSB 2 gets beam direction 1, SSB 4 gets beam direction index 2, etc.

However, it should be pointed out that regardless of which mapping between SSB index and beam direction index that is chosen in the reference SSB beam sweep configuration, this mapping is valid only in this reference SSB beams sweep configuration. The SSB indexes are tied to candidate SSB positions, i.e. essentially time slots, whereas the beam direction indexes are tied to spatial beam configurations (i.e. beam directions). So, if the relation between timing and beam direction is changed when the SSB beam sweep is reconfigured, the SSB index to beam direction index will be different.

The reference SSB beam sweep configuration could for instance be the beam sweep configuration configured during deployment of a cell (or after a major deployment change, e.g. involving a change of the spatial configuration of the SSB beams (e.g. changing the antenna weights or antenna element weights), with or without changing the number of SSBs)). Any subsequent SSB beam sweep reconfiguration may be described, and signaled, using the beam direction indexes, wherein each of these beam direction indexes maintains its reference to a certain spatial direction (i.e. a certain spatial beam). Hence, after one or more SSB beam sweep reconfigurations, the SSB indexes will still be transmitted in sequential order (since they are tied to candidate SSB positions, i.e. time slots), while the beam direction indexes may have any arbitrary order. Note also that another difference between SSB indexes and beam direction indexes is that SSB indexes are encoded in the data/signals transmitted in the SSB, while the beam direction indexes are merely used for the purpose of description of SSB beam sweep reconfigurations. As such, the beam direction indexes are not transmitted across the radio interface to the UE, but may be transmitted from a gNB-DU to a gNB-CU.

When the concept of beam direction indexes has been introduced, and each spatial beam in an SSB beam sweep is associated with a respective beam direction index (established for a reference beam sweep configuration), the tables presented above could have their rightmost column (with the title “The impacted SSB's new beam direction in terms of beam directions in the old SSB beam sweep configuration”) replaced by a column indicating the new SSB beams' directions in terms of beam direction indexes (e.g. with the column title “The impacted SSB's new beam direction index”). If multiple beam sweep reconfigurations are performed sequentially, the gNB-CU may have to keep track of the beam direction index associated with each SSB beam (i.e. with each SSB index) to fully determine the consequences of each performed beam sweep reconfiguration (although the gNB-CU will be able to perform relevant actions based on the beam sweep reconfiguration information signaled from the gNB-DU even without such tracking).

To illustrate how this turns out, we repeat the summary of the tables (associated with the example cases of SSB/spatial beam rearrangement above), but here with the rightmost table replaced as described above:

Swapping the beam directions of SSB 0 and SSB 2 (ssb-PositionsInBurst unchanged).

First, assuming that the described/signaled SSB beams sweep reconfiguration is the first one after the reference SSB beam sweep configuration was established and wherein it is assumed that in the reference SSB beam sweep configuration, each beam direction index was set to the same value as the SSB index of the associated SSB.

TABLE 13
New SSB Beam Direction Index

| Impacted | New SSB | The impacted SSB's new |
|---|---|---|
| SSB | index | beam direction index |
| SSB 0 | 0 | 2 |
| SSB 2 | 2 | 0 |

Now assuming that an arbitrary number of prior SSB beam sweep reconfiguration(s) may have been performed after the reference SSB beam sweep configuration was established.

TABLE 14
New SSB Beam Direction Index

| Impacted | New SSB | The impacted SSB's new |
|---|---|---|
| SSB | index | beam direction index |
| SSB 0 | 0 | X |
| SSB 2 | 2 | Y |

When an arbitrary number of prior SSB beam sweep reconfiguration(s) may have been performed after the reference SSB beam sweep configuration was established, the resulting beam direction indexes after this swap operation depends on the history of the prior SSB beam sweep reconfiguration(s) (if any) and the letters “X” and “Y” above hence represent numbers (beam direction index values) that depend on how beam direction indexes have been rearranged/changed during the possible prior SSB beam sweep reconfiguration(s). The gNB-DU thus keeps track of how the SSB index to beam direction index associations change through every SSB beam sweep reconfiguration and in an actual case of signaling of the SSB beam sweep reconfiguration information, “X” and “Y” in the table above would be the actual numbers (beam direction index values) of the beam direction indexes. In this particular case of swapping of the spatial beams of SSB 0 and SSB 2, X is the beam direction index SSB 2 had before the swap and Y is the beam direction index SSB 0 had before the swap.

Sequential SSB beam direction change/shift SSB 0→SSB 1→SSB 2→SSB 0 (ssb-PositionsInBurst unchanged).

First, assuming that the described/signaled SSB beams sweep reconfiguration is the first one after the reference SSB beam sweep configuration was established and wherein it is assumed that in the reference SSB beam sweep configuration, each beam direction index was set to the same value as the SSB index of the associated SSB.

TABLE 15
New SSB Beam Direction Index

| Impacted | New SSB | The impacted SSB's new |
|---|---|---|
| SSB | index | beam direction index |
| SSB 0 | 0 | 1 |
| SSB 1 | 1 | 2 |
| SSB 2 | 2 | 0 |

Now assuming that an arbitrary number of prior SSB beam sweep reconfiguration(s) may have been performed after the reference SSB beam sweep configuration was established.

TABLE 16
New SSB Beam Direction Index

| Impacted | New SSB | The impacted SSB's new |
|---|---|---|
| SSB | index | beam direction index |
| SSB 0 | 0 | X |
| SSB 1 | 1 | Y |
| SSB 2 | 2 | Z |

As in the swapping case, when an arbitrary number of prior SSB beam sweep reconfiguration(s) may have been performed after the reference SSB beam sweep configuration was established, the resulting beam direction indexes after this sequential change/shift operation depends on the history of the prior SSB beam sweep reconfiguration(s) (if any) and the letters “X”, “Y” and “Z” above hence represent numbers (beam direction index values) that depend on how beam direction indexes have been rearranged/changed during the possible prior SSB beam sweep reconfiguration(s). The gNB-DU thus keeps track of how the SSB index to beam direction index associations change through every SSB beam sweep reconfiguration and in an actual case of signaling of the SSB beam sweep reconfiguration information, “X”, “Y” and “Z” in the table above would be the actual numbers (beam direction index values) of the beam direction indexes. In this particular case of sequential change/shift of the spatial beams of SSB 0, SSB 1 and SSB 2, X is the beam direction index SSB 1 had before the sequential change/shift, Y is the beam direction index SSB 2 had before the sequential change/shift and Z is the beam direction index SSB 0 had before the sequential change/shift.

Change of SSB index (and thus timing) with retained beam direction (SSB 1 gets index 2, ssb-PositionsInBurst changed from 1100 to 1010).

First, assuming that the described/signaled SSB beams sweep reconfiguration is the first one after the reference SSB beam sweep configuration was established and wherein it is assumed that in the reference SSB beam sweep configuration, each beam direction index was set to the same value as the SSB index of the associated SSB.

TABLE 17
New SSB Beam Direction Index

| Impacted | New SSB | The impacted SSB's new |
|---|---|---|
| SSB | index | beam direction index |
| SSB 1 | 2 | 1 |

Now assuming that an arbitrary number of prior SSB beam sweep reconfiguration(s) may have been performed after the reference SSB beam sweep configuration was established.

TABLE 18
New SSB Beam Direction Index

| Impacted | New SSB | The impacted SSB's new |
|---|---|---|
| SSB | index | beam direction index |
| SSB 1 | 2 | X |

As in the cases of swapping and sequential change/shift, when an arbitrary number of prior SSB beam sweep reconfiguration(s) may have been performed after the reference SSB beam sweep configuration was established, the resulting beam direction index after this SSB index change (i.e. change of candidate SSB position, i.e. change of time of transmission of the SSB beam) depends on the history of the prior SSB beam sweep reconfiguration(s) (if any) and the letter “X” above hence represent a number (beam direction index value) that depends on how beam direction indexes have been rearranged/changed during the possible prior SSB beam sweep reconfiguration(s). The gNB-DU thus keeps track of how the SSB index to beam direction index associations change through every SSB beam sweep reconfiguration and in an actual case of signaling of the SSB beam sweep reconfiguration information, “X” in the table above would be the actual number (beam direction index value) of the beam direction index. In this particular case of SSB index change (i.e. change of time of transmission to a new candidate SSB position while retaining the same spatial beam), X is the same beam direction index as the spatial beam had before the change of SSB index (i.e. the beam direction index SSB 1 had before it was changed into SSB 2).

Change of SSB index combined with beam direction swap (SSB 1 gets index 2 and the beam direction of SSB 0, SSB 0 gets the beam direction of the old SSB 1, ssb-PositionsInBurst changed from 1100 to 1010).

First, assuming that the described/signaled SSB beams sweep reconfiguration is the first one after the reference SSB beam sweep configuration was established and wherein it is assumed that in the reference SSB beam sweep configuration, each beam direction index was set to the same value as the SSB index of the associated SSB.

TABLE 19
New SSB Beam Direction Index

| Impacted | New SSB | The impacted SSB's new |
|---|---|---|
| SSB | index | beam direction index |
| SSB 0 | 0 | 1 |
| SSB 1 | 2 | 0 |

Now assuming that an arbitrary number of prior SSB beam sweep reconfiguration(s) may have been performed after the reference SSB beam sweep configuration was established.

TABLE 20
New SSB Beam Direction Index

| Impacted | New SSB | The impacted SSB's new |
|---|---|---|
| SSB | index | beam direction index |
| SSB 0 | 0 | X |
| SSB 1 | 2 | Y |

As in the previously described cases, when an arbitrary number of prior SSB beam sweep reconfiguration(s) may have been performed after the reference SSB beam sweep configuration was established, the resulting beam direction indexes after this swap operation depends on the history of the prior SSB beam sweep reconfiguration(s) (if any) and the letters “X” and “Y” above hence represent numbers (beam direction index values) that depend on how beam direction indexes have been rearranged/changed during the possible prior SSB beam sweep reconfiguration(s). The gNB-DU thus keeps track of how the SSB index to beam direction index associations change through every SSB beam sweep reconfiguration and in an actual case of signaling of the SSB beam sweep reconfiguration information, “X” and “Y” in the table above would be the actual numbers (beam direction index values) of the beam direction indexes. In this particular case of SSB index change combined with spatial beam swapping, X is the beam direction index SSB I had before it was changed into SSB 2 and which this new SSB 2 retained across the SSB index change before the swap of spatial beams with SSB 0, and Y is the beam direction index SSB 0 had before the swap of spatial beams.

Table 21 illustrates an example of how the type of table presented above can be captured in IE specifications, e.g. in 3GPP TS 38.473, using a list of triplets.

TABLE 21
Example IE

| | | | IE type and | |
|---|---|---|---|---|
| IE/Group Name | Presence | Range | reference | Semantics description |
| SS-PBCH burst | | | | This IE can convey |
| (re)configuration | | | | information about a |
| | | | | reference SS/PBCH block |
| | | | | beam sweep |
| | | | | configuration or an |
| | | | | SS/PBCH block beam |
| | | | | sweep reconfiguration. |
| | | | | When the IE conveys |
| | | | | information about a |
| | | | | reference SS/PBCH block |
| | | | | beam sweep |
| | | | | configuration, the “New |
| | | | | SS-PBCH block index” is |
| | | | | not included. When the IE |
| | | | | conveys information |
| | | | | about an SS/PBCH block |
| | | | | beam sweep |
| | | | | reconfiguration, the “New |
| | | | | SS-PBCH block index” |
| | | | | and/or the “New beam |
| | | | | direction index” may or |
| | | | | may not be included. |
| >Impacted SS-PBCH | | 1 . . . <maxnoof | | |
| blocks | | SS-PBCH-Blocks> | | |
| >>Impacted SS-PBCH | M | | INTEGER | |
| block index | | | (0 . . . 63, . . .) | |
| >>New SS-PBCH block | O | | INTEGER | |
| index | | | (0 . . . 63, . . .) | |
| >>New beam direction | O | | INTEGER | |
| index | | | (0 . . . 63, . . .) | |

Note that if the optional parameters are omitted in the above IE example, the remaining information is the rudimentary SSB beam sweep reconfiguration information that only indicates the SSB indexes of the SSBs impacted by the reconfiguration.

In another IE specification example shown in Table 22, the type of table presented above is captured using three correspondingly ordered parameter lists.

TABLE 22
Example IE

| | | | IE type and | |
|---|---|---|---|---|
| IE/Group Name | Presence | Range | reference | Semantics description |
| SS-PBCH burst | | | | This IE can convey |
| (re)configuration | | | | information about a |
| | | | | reference SS/PBCH block |
| | | | | beam sweep |
| | | | | configuration or an |
| | | | | SS/PBCH block beam |
| | | | | sweep reconfiguration. |
| | | | | When the IE conveys |
| | | | | information about a |
| | | | | reference SS/PBCH block |
| | | | | beam sweep |
| | | | | configuration, the “New |
| | | | | SS-PBCH block indexes” |
| | | | | is not included. When the |
| | | | | IE conveys information |
| | | | | about an SS/PBCH block |
| | | | | beam sweep |
| | | | | reconfiguration, the “New |
| | | | | SS-PBCH block indexes” |
| | | | | and/or the “New beam |
| | | | | direction indexes” may or |
| | | | | may not be included. |
| >Impacted SS-PBCH | | 1 . . . <maxnoof | | |
| blocks | | SS-PBCH-Blocks> | | |
| >>Impacted SS-PBCH | M | | INTEGER | |
| block index | | | (0 . . . 63, . . .) | |
| >New SS-PBCH block | | 1 . . . <maxnoof | | If this list is |
| indexes | | SS-PBCH-Blocks> | | included/present, it must |
| | | | | have the same number of |
| | | | | items as the “Impacted |
| | | | | SS-PBCH blocks” list. |
| | | | | The first item in the list |
| | | | | corresponds to the first |
| | | | | item in the “Impacted SS- |
| | | | | PBCH blocks” list. The |
| | | | | second item in the list |
| | | | | corresponds to the |
| | | | | second item in the |
| | | | | “Impacted SS-PBCH |
| | | | | blocks” list, etc. |
| >>New SS-PBCH block | O | | INTEGER | |
| index | | | (0 . . . 63, . . .) | |
| >New beam direction | | 1 . . . <maxnoof | | If this list is |
| indexes | | SS-PBCH-Blocks> | | included/present, it must |
| | | | | have the same number of |
| | | | | items as the “Impacted |
| | | | | SS-PBCH blocks” list. |
| | | | | The first item in the list |
| | | | | corresponds to the first |
| | | | | item in the “Impacted SS- |
| | | | | PBCH blocks” list. The |
| | | | | second item in the list |
| | | | | corresponds to the |
| | | | | second item in the |
| | | | | “Impacted SS-PBCH |
| | | | | blocks” list, etc. |
| >>New beam direction | O | | INTEGER | |
| index | | | (0 . . . 63, . . .) | |

Note that if the optional parameters are omitted in the above IE example, the remaining information is the rudimentary SSB beam sweep reconfiguration information that only indicates the SSB indexes of the SSBs impacted by the reconfiguration.

In another embodiment where a table including beam direction index(es) is used to represent an SSB beam sweep reconfiguration (or to represent an SSB beam sweep configuration, e.g. the SSB beam sweep configuration resulting from an SSB beam sweep reconfiguration), there is one column for each SSB index. As one option, all SSB indexes in the SSB beam sweep may be represented in the table. As another option, only the SSB indexes whose SSBs in one way or the other are affected by the SSB beam sweep reconfiguration (e.g. in terms of change of SSB index, i.e. time of transmission, and/or change of beam direction index, i.e. change of spatial beam) are included in the table.

Table 22 illustrates an of a sequential shift operation (i.e. the spatial beams are shifted in a sequence among a set of SSBs). The SSB beam sweep configuration before the sequential shift operation (i.e. before the SSB beam sweep reconfiguration) is illustrated by Table 23.

TABLE 23
Sequential Shift Operation Example

| SSB index 0 | SSB index 1 | SSB index 2 | SSB index 3 |
|---|---|---|---|
| Time slot 0 | Time slot 1 | Time slot 2 | Time slot 3 |
| Beam direction | Beam direction | Beam direction | Beam direction |
| index 0 | index 1 | index 2 | index 3 |

Then the sequential shift is performed (i.e. the SSB beam sweep is reconfigured) and the resulting SSB beam sweep configuration is illustrated by Table 24.

TABLE 24
Sequential Shift Operation Example

| SSB index 0 | SSB index 1 | SSB index 2 | SSB index 3 |
|---|---|---|---|
| Time slot 0 | Time slot 1 | Time slot 2 | Time slot 3 |
| Beam direction | Beam direction | Beam direction | Beam direction |
| index 3 | index 0 | index 1 | index 2 |

The following additional example illustrates an SSB beam sweep reconfiguration where the spatial beams (represented by their beam direction indexes) are swapped between SSB 0 and SSB 2. The SSB beam sweep configuration before the sequential shift operation (i.e. before the SSB beam sweep reconfiguration) is illustrated by Table 25.

TABLE 25
Sequential Shift Operation Example

| SSB index 0 | SSB index 1 | SSB index 2 | SSB index 3 |
|---|---|---|---|
| Time slot 0 | Time slot 1 | Time slot 2 | Time slot 3 |
| Beam direction | Beam direction | Beam direction | Beam direction |
| index 0 | index 1 | index 2 | index 3 |

Then the spatial beam swapping operation is performed (i.e. the SSB beam sweep is reconfigured) and the resulting beam sweep configuration is illustrated by Table 26.

TABLE 26
Sequential Shift Operation Example

| SSB index 0 | SSB index 1 | SSB index 2 | SSB index 3 |
|---|---|---|---|
| Time slot 0 | Time slot 1 | Time slot 2 | Time slot 3 |
| Beam direction | Beam direction | Beam direction | Beam direction |
| index 2 | index 1 | index 0 | index 3 |

In another example (where SSB indexes 0, 2, 4 and 6 are used before the SSB beam sweep reconfiguration), SSB 0 is changed to SSB 1 (i.e. the time of transmission is changed from candidate SSB position 0 to candidate SSB position 1) while its spatial beam configuration, and thus its beam direction index, is retained. Table 27 illustrates the SSB beam sweep configuration before the SSB beam sweep reconfiguration.

TABLE 27
Beam Sweep Configuration Example

| SSB index 0 | SSB index 2 | SSB index 4 | SSB index 6 |
|---|---|---|---|
| Time slot 0 | Time slot 2 | Time slot 4 | Time slot 6 |
| Beam direction | Beam direction | Beam direction | Beam direction |
| index 0 | index 1 | index 2 | index 3 |

Then the SSB index change is performed (i.e. SSB 0 is turned into SSB 1 while retaining its spatial beam configuration) and the resulting SSB beam sweep configuration is illustrated by Table 28.

TABLE 28
Beam Sweep Configuration Example

| SSB index 1 | SSB index 2 | SSB index 4 | SSB index 6 |
|---|---|---|---|
| Time slot 1 | Time slot 2 | Time slot 4 | Time slot 6 |
| Beam direction | Beam direction | Beam direction | Beam direction |
| index 0 | index 1 | index 2 | index 3 |

The type of table used in the above examples may easily be turned into a parameter structure, e.g. a set of triplets (where each triplet includes the parameter values of one column) used when the SSB beam sweep (re) configuration information is signaled from a gNB-DU to a gNB-CU. Another parameter structure option could be to use three lists of parameter values, where the first list includes the SSB indexes, the second list includes the corresponding time slots (i.e. the candidate SSB positions in which the SSBs are transmitted) and the second third list includes the corresponding beam direction indexes.

Note that it suffices to signal the information in the second table in each example, i.e. the information describing the SSB beam sweep configuration resulting from the SSB beam sweep reconfiguration (i.e. the new SSB beam sweep configuration).

In the above example tables where both the SSB index and the time slot are included in each column contain redundant information, since the time slot can be deduced from the SSB index. The time slot is equivalent to the candidate SSB position used for transmission of the SSB with the concerned SSB index and the SSB index is unambiguously associated with the candidate SSB position in which is transmitted. This hence makes the presence of the time slots in the table redundant if the SSB indexes are included. Therefore, alternative tables, providing equivalent information, may be constructed by removing the time slot row from the example tables above. This results in the following tables and associated example text.

The following example illustrates a sequential shift operation (i.e. the spatial beams are shifted in a sequence among a set of SSBs). The SSB beam sweep configuration before the sequential shift operation (i.e. before the SSB beam sweep reconfiguration) is illustrated in Table 29.

TABLE 29
Beam Sweep Configuration Example

| SSB index 0 | SSB index 1 | SSB index 2 | SSB index 3 |
|---|---|---|---|
| Beam direction | Beam direction | Beam direction | Beam direction |
| index 0 | index 1 | index 2 | index 3 |

Then the sequential shift is performed (i.e. the SSB beam sweep is reconfigured) and the resulting SSB beam sweep configuration is illustrated by Table 30.

TABLE 30
Beam Sweep Configuration Example

| SSB index 0 | SSB index 1 | SSB index 2 | SSB index 3 |
|---|---|---|---|
| Beam direction | Beam direction | Beam direction | Beam direction |
| index 3 | index 0 | index 1 | index 2 |

The following additional example illustrates an SSB beam sweep reconfiguration where the spatial beams (represented by their beam direction indexes) are swapped between SSB 0 and SSB 2. The SSB beam sweep configuration before the sequential shift operation (i.e. before the SSB beam sweep reconfiguration) is illustrated by Table 31.

TABLE 31
Beam Sweep Configuration Example

| SSB index 0 | SSB index 1 | SSB index 2 | SSB index 3 |
|---|---|---|---|
| Beam direction | Beam direction | Beam direction | Beam direction |
| index 0 | index 1 | index 2 | index 3 |

Then the spatial beam swapping operation is performed (i.e. the SSB beam sweep is reconfigured) and the resulting beam sweep configuration is illustrated by Table 32.

TABLE 32
Beam Sweep Configuration Example

| SSB index 0 | SSB index 1 | SSB index 2 | SSB index 3 |
|---|---|---|---|
| Beam direction | Beam direction | Beam direction | Beam direction |
| index 2 | index 1 | index 0 | index 3 |

In another example (where SSB indexes 0, 2, 4 and 6 are used before the SSB beam sweep reconfiguration), SSB 0 is changed to SSB 1 (i.e. the time of transmission is changed from candidate SSB position 0 to candidate SSB position 1) while its spatial beam configuration, and thus its beam direction index, is retained. Table 33 illustrates the SSB beam sweep configuration before the SSB beam sweep reconfiguration.

TABLE 33
Beam Sweep Configuration Example

| SSB index 0 | SSB index 2 | SSB index 4 | SSB index 6 |
|---|---|---|---|
| Beam direction | Beam direction | Beam direction | Beam direction |
| index 0 | index 1 | index 2 | index 3 |

Then the SSB index change is performed (i.e. SSB 0 is turned into SSB 1 while retaining its spatial beam configuration) and the resulting SSB beam sweep configuration is illustrated by Table 34.

TABLE 34
Beam Sweep Configuration Example

| SSB index 1 | SSB index 2 | SSB index 4 | SSB index 6 |
|---|---|---|---|
| Beam direction | Beam direction | Beam direction | Beam direction |
| index 0 | index 1 | index 2 | index 3 |

The type of table used in the above examples may easily be turned into a parameter structure, e.g. a set of duplets or a set of parameter pairs (where each duplet or parameter pair includes the parameter values of one column) used when the SSB beam sweep (re)configuration information is signaled from a gNB-DU to a gNB-CU. Another parameter structure option could be to use two lists of parameter values, where the first list includes the SSB indexes and the second list includes the corresponding beam direction indexes.

Note that it suffices to signal the information in the second table in each example, i.e. the information describing the SSB beam sweep configuration resulting from the SSB beam sweep reconfiguration (i.e. the new SSB beam sweep configuration).

This type of table could be captured in an IE specification, e.g. in the F1AP specification 3GPP TS 38.473, using a set of parameter pairs as shown in Table 35.

TABLE 35
Example IE Specification

| | | | IE type and | |
|---|---|---|---|---|
| IE/Group Name | Presence | Range | reference | Semantics description |
| SS-PBCH burst | | | | Includes the configuration |
| (re)configuration | | | | of the SS/PBCH block |
| | | | | indexes and the beam |
| | | | | direction indexes |
| | | | | associated with the |
| | | | | SS/PBCH blocks in an |
| | | | | SS/PBCH block beam |
| | | | | sweep. This may be an |
| | | | | initial SS/PBCH block |
| | | | | beam sweep |
| | | | | configuration or the result |
| | | | | of an SS/PBCH block |
| | | | | beam sweep |
| | | | | reconfiguration. |
| >SS-PBCH block | | 1 . . . <maxnoof | | |
| configurations | | SS-PBCH-Blocks> | | |
| >>Candidate SS-PBCH | M | | INTEGER | |
| block index | | | (0 . . . 63, . . .) | |
| >>Beam direction index | O | | INTEGER | |
| | | | (0 . . . 63, . . .) | |

The above IE example may be used in two different ways. As one option, it always includes all the SSBs in the SSB beam sweep, i.e. all utilized SSB indexes, in which case it will always describe a complete SSB beam sweep configuration in terms of utilized SSB indexes and associated beam direction indexes. As another option, the IE may include all or a subset of the SSBs in the SSB beam sweep. The option to let the IE contain only a subset of the SSBs in the SSB beam sweep can be used to signal a SSB beam sweep reconfiguration, wherein the SSBs that are unaffected by the reconfiguration are omitted in the IE. In addition, if the optional “Beam direction index” parameter is omitted in the above IE example when the option to let the IE contain only the subset of the SSBs in the SSB beam sweep that is/are impacted by a performed SSB beam sweep reconfiguration, the remaining information is the rudimentary SSB beam sweep reconfiguration information that only indicates the SSB indexes of the SSBs impacted by the reconfiguration.

If all the SSBs in the SSB beam sweep, i.e. all utilized SSB indexes, are always included in the above IE example, i.e. not only the SSBs affected by the latest SSB beam sweep reconfiguration, then the IE can be simplified if the ssb-PositionsInBurst parameter is also transferred from the gNB-DU to the gNB-CU, or is already known by the receiver, i.e. the gNB-CU. In such a case, the “Candidate SS-PBCH block index” parameter above is redundant, since these values can be derived from the ssb-PositionsInBurst parameter. Then a simplified IE example could be as shown in Table 36 or, more simply, in Table 37.

TABLE 36
Example IE Specification

| | | | IE type and | |
|---|---|---|---|---|
| IE/Group Name | Presence | Range | reference | Semantics description |
| SS-PBCH burst | | | | Includes the configuration |
| configuration | | | | of the beam direction |
| | | | | indexes associated with |
| | | | | the SS/PBCH blocks |
| | | | | transmitted in an entire |
| | | | | SS/PBCH block beam |
| | | | | sweep. This may be an |
| | | | | initial SS/PBCH block |
| | | | | beam sweep |
| | | | | configuration or the result |
| | | | | of an SS/PBCH block |
| | | | | beam sweep |
| | | | | reconfiguration. |
| >SS-PBCH block | | 1 . . . <maxnoof | | |
| configurations | | SS-PBCH-Blocks> | | |
| >>Beam direction index | M | | INTEGER | Indicates the beam |
| | | | (0 . . . 63, . . .) | direction indexes |
| | | | | associated with the |
| | | | | SS/PBCH blocks |
| | | | | transmitted in the cell as |
| | | | | indicated by the ssb- |
| | | | | PositionsInBurst |
| | | | | parameter. The first beam |
| | | | | direction index is |
| | | | | associated with the |
| | | | | SS/PBCH block |
| | | | | transmitted in the first |
| | | | | candidate SS/PBCH |
| | | | | block position for which |
| | | | | the corresponding bit is |
| | | | | set to 1 in the ssb- |
| | | | | PositionsInBurst |
| | | | | parameter. The second |
| | | | | beam direction index is |
| | | | | associated with the |
| | | | | SS/PBCH block |
| | | | | transmitted in the second |
| | | | | candidate SS/PBCH |
| | | | | block position for which |
| | | | | the corresponding bit is |
| | | | | set to 1 in the ssb- |
| | | | | PositionsInBurst |
| | | | | parameter, etc. |

TABLE 37
Example IE Specification

| | | | IE type and | |
|---|---|---|---|---|
| IE/Group Name | Presence | Range | reference | Semantics description |
| SS-PBCH block | | 1 . . . <maxnoof | | Includes the configuration |
| configurations | | SS-PBCH-Blocks> | | of the beam direction |
| | | | | indexes associated with |
| | | | | the SS/PBCH blocks |
| | | | | transmitted in an entire |
| | | | | SS/PBCH block beam |
| | | | | sweep. This may be an |
| | | | | initial SS/PBCH block |
| | | | | beam sweep |
| | | | | configuration or the result |
| | | | | of an SS/PBCH block |
| | | | | beam sweep |
| | | | | reconfiguration. |
| >Beam direction index | M | | INTEGER | Indicates the beam |
| | | | (0 . . . 63, . . .) | direction indexes |
| | | | | associated with the |
| | | | | SS/PBCH blocks |
| | | | | transmitted in the cell as |
| | | | | indicated by the ssb- |
| | | | | PositionsInBurst |
| | | | | parameter. The first beam |
| | | | | direction index is |
| | | | | associated with the |
| | | | | SS/PBCH block |
| | | | | transmitted in the first |
| | | | | candidate SS/PBCH |
| | | | | block position for which |
| | | | | the corresponding bit is |
| | | | | set to 1 in the ssb- |
| | | | | PositionsInBurst |
| | | | | parameter. The second |
| | | | | beam direction index is |
| | | | | associated with the |
| | | | | SS/PBCH block |
| | | | | transmitted in the second |
| | | | | candidate SS/PBCH |
| | | | | block position for which |
| | | | | the corresponding bit is |
| | | | | set to 1 in the ssb- |
| | | | | PositionsInBurst |
| | | | | parameter, etc. |

In another IE specification example, this type of table could be captured in an IE specification, e.g. in the F1AP specification 3GPP TS 38.473, using two lists as shown in Table 38.

TABLE 38
Example IE Specification

| | | | IE type and | |
|---|---|---|---|---|
| IE/Group Name | Presence | Range | reference | Semantics description |
| SS-PBCH burst | | | | Includes the configuration |
| (re)configuration | | | | of utilized candidate |
| | | | | SS/PBCH block positions |
| | | | | and associated beam |
| | | | | direction indexes in an |
| | | | | SS/PBCH block beam |
| | | | | sweep. This may be an |
| | | | | initial SS/PBCH block |
| | | | | beam sweep |
| | | | | configuration or the result |
| | | | | of an SS/PBCH block |
| | | | | beam sweep |
| | | | | reconfiguration. |
| >SS-PBCH block indexes | | 1 . . . <maxnoof | | The SS/PBCH block |
| | | SS-PBCH-Blocks> | | indexes associated with |
| | | | | the SS/PBCH blocks |
| | | | | broadcast in the cell. |
| >>SS-PBCH block index | M | | INTEGER | |
| | | | (0 . . . 63, . . .) | |
| >Beam direction indexes | | 1 . . . <maxnoof | | Indicates the beam |
| | | SS-PBCH-Blocks> | | direction indexes |
| | | | | associated with the |
| | | | | SS/PBCH blocks |
| | | | | transmitted in the cell. |
| | | | | The first beam direction |
| | | | | index is associated with |
| | | | | the first SS/PBCH block |
| | | | | index in the “SS-PBCH |
| | | | | block indexes” parameter. |
| | | | | The second beam |
| | | | | direction index is |
| | | | | associated with the |
| | | | | SS/PBCH block index in |
| | | | | the “SS-PBCH block |
| | | | | index” parameter, etc. |
| >>Beam direction index | O | | INTEGER | |
| | | | (0 . . . 63, . . .) | |

The above IE example may be used in two different ways. As one option, it always includes all the SSBs in the SSB beam sweep, i.e. all utilized SSB indexes, in which case it will always describe a complete SSB beam sweep configuration in terms of utilized SSB indexes and associated beam direction indexes. As another option, the IE may include all or a subset of the SSBs in the SSB beam sweep. The option to let the IE contain only a subset of the SSBs in the SSB beam sweep can be used to signal a SSB beam sweep reconfiguration, wherein the SSBs that are unaffected by the reconfiguration are omitted in the IE. In addition, if the optional “Beam direction index” parameter is omitted in the above IE example when the option to let the IE contain only the subset of the SSBs in the SSB beam sweep that is/are impacted by a performed SSB beam sweep reconfiguration, the remaining information is the rudimentary SSB beam sweep reconfiguration information that only indicates the SSB indexes of the SSBs impacted by the reconfiguration.

If all the SSBs in the beam sweep, i.e. all utilized SSB indexes, are always included in the above IE example, i.e. not only the SSBs affected by the latest SSB beam sweep reconfiguration, then the IE can be simplified if the ssb-PositionsInBurst parameter is also transferred from the gNB-DU to the gNB-CU, or is already known by the receiver, i.e. the gNB-CU. In such a case, the “SS-PBCH block indexes” parameter above is redundant, since these values can be derived from the ssb-PositionsInBurst parameter. Then a simplified IE example could be as shown in Table 39 (using only a single set of parameters), or, more simply, in Table 40.

TABLE 39
Example IE Specification

| | | | IE type and | |
|---|---|---|---|---|
| IE/Group Name | Presence | Range | reference | Semantics description |
| SS-PBCH burst | | | | Includes the configuration |
| configuration | | | | of beam direction indexes |
| | | | | associated with the |
| | | | | SS/PBCH blocks |
| | | | | transmitted in an entire |
| | | | | SS/PBCH block beam |
| | | | | sweep. This may be an |
| | | | | initial SS/PBCH block |
| | | | | beam sweep |
| | | | | configuration or the result |
| | | | | of an SS/PBCH block |
| | | | | beam sweep |
| | | | | reconfiguration. |
| >Beam direction indexes | | 1 . . . <maxnoof | | Indicates the beam |
| | | SS-PBCH-Blocks> | | direction indexes |
| | | | | associated with the |
| | | | | SS/PBCH blocks |
| | | | | transmitted in the cell. |
| | | | | The first beam direction |
| | | | | index is associated with |
| | | | | the SS/PBCH block |
| | | | | transmitted in the first |
| | | | | candidate SS/PBCH |
| | | | | block position for which |
| | | | | the corresponding bit is |
| | | | | set to 1 in the ssb- |
| | | | | PositionsInBurst |
| | | | | parameter. The second |
| | | | | beam direction index is |
| | | | | associated with the |
| | | | | SS/PBCH block |
| | | | | transmitted in the second |
| | | | | candidate SS/PBCH |
| | | | | block position for which |
| | | | | the corresponding bit is |
| | | | | set to 1 in the ssb- |
| | | | | PositionsInBurst |
| | | | | parameter, etc. |
| >>Beam direction index | M | | INTEGER | |
| | | | (0 . . . 63, . . .) | |

TABLE 40
Example IE Specification

| | | | IE type and | |
|---|---|---|---|---|
| IE/Group Name | Presence | Range | reference | Semantics description |
| Beam direction indexes | | 1 . . . <maxnoof | | Includes the configuration |
| | | SS-PBCH-Blocks> | | of beam direction indexes |
| | | | | for an entire SS/PBCH |
| | | | | block beam sweep. This |
| | | | | may be an initial |
| | | | | SS/PBCH block beam |
| | | | | sweep configuration or |
| | | | | the result of an SS/PBCH |
| | | | | block beam sweep |
| | | | | reconfiguration. Hence, it |
| | | | | indicates the beam |
| | | | | direction indexes |
| | | | | associated with the |
| | | | | SS/PBCH blocks |
| | | | | transmitted in the cell. |
| | | | | The first beam direction |
| | | | | index is associated with |
| | | | | the SS/PBCH block |
| | | | | transmitted in the first |
| | | | | candidate SS/PBCH |
| | | | | block position for which |
| | | | | the corresponding bit is |
| | | | | set to 1 in the ssb- |
| | | | | PositionsInBurst |
| | | | | parameter. The second |
| | | | | beam direction index is |
| | | | | associated with the |
| | | | | SS/PBCH block |
| | | | | transmitted in the second |
| | | | | candidate SS/PBCH |
| | | | | block position for which |
| | | | | the corresponding bit is |
| | | | | set to 1 in the ssb- |
| | | | | PositionsInBurst |
| | | | | parameter, etc. |
| >Beam direction index | M | | INTEGER | |
| | | | (0 . . . 63, . . .) | |

### Further Signaling Scenarios

In addition to signaling of SSB beam sweep reconfiguration information from a gNB-DU to a gNB-CU, the signaling means presented above may be used in other signaling scenarios.

In one scenario, a gNB-CU signals information about an SSB beam sweep reconfiguration to one of its connected gNB-DUs. The gNB-CU may for instance have detected implications of a conflict/collision between two cells and uses the signaling means to instruct the gNB-DU serving one of the cells to change the SSB beam sweep configuration in the cell in accordance with the signaled information in order to resolve the conflict/collisions (i.e. in this case the signaled information constitutes an instruction of SSB beam sweep reconfiguration operation(s) the gNB-DU should perform rather than information about an already performed SSB beam sweep reconfiguration). Such implications of neighbor cell conflicts/collisions may e.g. come in the form of statistics of operation performance, e.g. statistics of RACH failures or other events, and/or information about possible conflicts/collisions received from another network node, such as a gNB-DU, another gNB-CU or an O&M node. As an alternative of an instruction of SSB beam sweep reconfiguration operation(s) to be performed, the signaled instruction may contain information about a full new SSB beam sweep configuration to employ (i.e. replacing any previous SSB beam sweep configuration). In this scenario, e previously proposed information structures and information elements (IEs) may be incorporated in F1AP (i.e. the signaling protocol used between a gNB-CU and a gNB-DU), either utilizing newly introduced messages for this purpose or utilizing existing messages, such as the ACCESS AND MOBILITY INDICATION message or the GNB-CU CONFIGURATION UPDATE and GNB-CU CONFIGURATION UPDATE ACKNOWLEDGE messages, extended with the new IE(s). F1AP is specified in 3GPP TS 38.473.

In another scenario, a first gNB-CU sends information to a second (neighboring) gNB-CU to inform the second gNB-CU about an SSB beam sweep reconfiguration performed in one of the first gNB-CU's cells, wherein this cell may be a neighbor of at least one of the second gNB-CU's cells. In this scenario, the previously proposed information structures and information elements (IEs) may be incorporated in XnAP (i.e. the signaling protocol used between gNB-CUs), either utilizing newly introduced messages for this purpose or utilizing existing messages, such as the NG-RAN NODE CONFIGURATION UPDATE and NG-RAN NODE CONFIGURATION UPDATE ACKNOWLEDGE messages, extended with the new IE(s). XnAP is specified in 3GPP TS 38.423.

In yet another scenario, the SSB beam sweep reconfiguration information may be signaled from an O&M node/entity to a gNB-CU or a gNB-DU, wherein the SSB beam sweep reconfiguration information constitutes an instruction of one or more SSB beam sweep reconfiguration operation(s) to be performed, or an instruction of a full new SSB beam sweep configuration to employ (i.e. replacing any previous SSB beam sweep configuration).

### Generalization to Other Beam Swept Signals

The above described embodiments involving reporting of beam sweep reconfigurations can to a large extent be generalized to apply to reporting of reconfigurations of beam sweeps for other signals than SSB too. Some examples of signals that could potentially be subject for such reporting include (but are not limited to) CSI-RS, DRS (for NR or LTE operating in shared (unlicensed) spectrum), PRS, and PTRS.

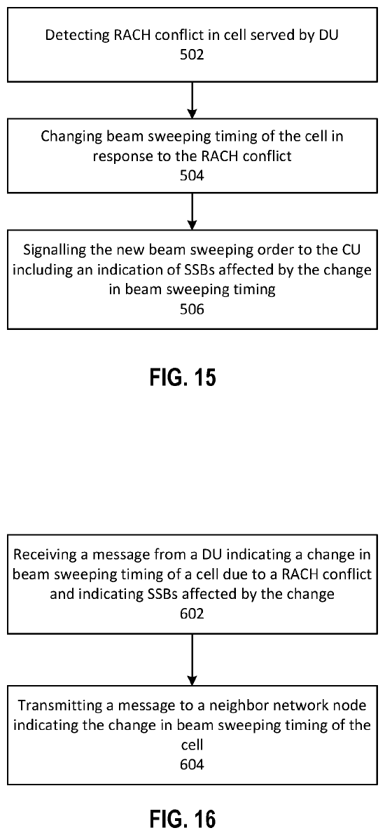

FIG. 15 illustrates a method of operating a distributed unit, DU, of a network node. The method includes detecting a random access channel, RACH, configuration conflict for a cell served by the DU in which synchronization signal blocks, SSBs, having different SSB indices are transmitted using a plurality of spatial beams according to a beam sweeping timing (block 502), and changing the beam sweeping timing of the cell from an original beam sweeping timing to a new beam sweeping timing in response to detecting the RACH conflict (block 504). The DU signals the new beam sweeping timing to a control unit, CU, of the network node (block 506). Signalling the new beam sweeping timing to the CU includes signalling an indication of SSBs affected by the change in beam sweeping timing to the CU.

In some embodiments, changing the beam sweeping timing includes changing an association of one of the SSBs and one of the spatial beams.

In some embodiments, changing the beam sweeping timing includes changing a time slot in which one of the SSBs is transmitted on an associated spatial beam.

In some embodiments, changing the beam sweeping timing includes changing a direction of one of the spatial beams carrying an associated SSB.

In some embodiments, signalling the new beam sweeping timing to the CU includes signalling an indication of a change in sweeping timing of SSBs relative to the original beam sweeping timing.

In some embodiments, changing the beam sweeping timing includes changing SSB indices of SSBs affected by the change in beam sweeping timing.

In some embodiments, detecting the RACH configuration conflict is performed in response to information received from the CU regarding a possible RACH conflict with a neighbor cell. The information may include an indication of a RACH occasion that may be subject to a conflict and/or information about a neighbor cell RACH configuration.

In some embodiments, detecting the RACH configuration conflict is performed in response to information in a random access, RA, report and/or in response to detecting poor performance of a RA procedure.

In some embodiments, changing the beam sweeping timing includes changing a beam direction index of a beam associated with at least one of the SSBs.

In some embodiments, changing the beam sweeping timing includes changing a position of transmission of one of the SSBs in an SSB burst.

FIG. 16 illustrates a method of operating a control unit, CU, of a network node. The method includes receiving a message from a distributed unit, DU, of the network node indicating a change of a beam sweeping timing of a cell served by the DU in which synchronization signal blocks, SSBs, having different SSB indices are transmitted using a plurality of spatial beams according to a beam sweeping timing (block 602). The change of beam sweeping timing is from an original beam sweeping timing to a new beam sweeping timing, and the change of beam sweeping timing was performed in response to detecting a random access channel, RACH, configuration conflict for the cell. Moreover, the message indicating the change in beam sweeping includes an indication of SSBs affected by the change in beam sweeping timing.

The method further includes transmitting a message to a neighbor network node indicating the change in beam sweeping timing of the cell (block 604).

A network node according to some embodiments includes processing circuitry configured to perform any of the operations of any of the methods described above in connection with FIGS. 15 and/or 16, and power supply circuitry configured to supply power to the processing circuitry.

Some embodiments provide a network node configured to perform any of the operations of any of the methods described above in connection with FIGS. 15 and/or 16.

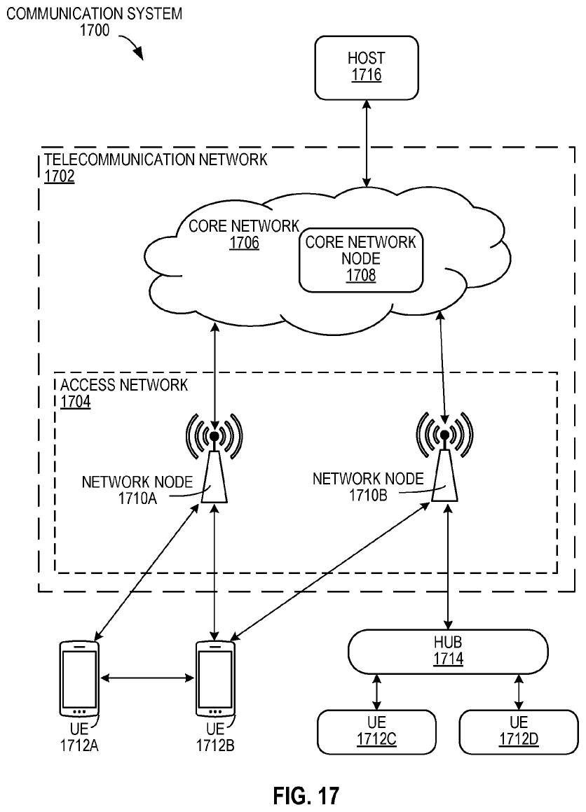

FIG. 17 shows an example of a communication system 1700 in accordance with some embodiments.

In the example, the communication system 1700 includes a telecommunication network 1702 that includes an access network 1704, such as a radio access network (RAN), and a core network 1706, which includes one or more core network nodes 1708. The access network 1704 includes one or more access network nodes, such as network nodes 1710a and 1710b (one or more of which may be generally referred to as network nodes 1710), or any other similar 3^{rd} Generation Partnership Project (3GPP) access node or non-3GPP access point. The network nodes 1710 facilitate direct or indirect connection of user equipment (UE), such as by connecting UEs 1712a, 1712b, 1712c, and 1712d (one or more of which may be generally referred to as UEs 1712) to the core network 1706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1700 may include any number of wired or wireless networks, network nodes, UEs, and/or any other components or systems that may facilitate or participate in the communication of data and/or signals whether via wired or wireless connections. The communication system 1700 may include and/or interface with any type of communication, telecommunication, data, cellular, radio network, and/or other similar type of system.

The UEs 1712 may be any of a wide variety of communication devices, including wireless devices arranged, configured, and/or operable to communicate wirelessly with the network nodes 1710 and other communication devices. Similarly, the network nodes 1710 are arranged, capable, configured, and/or operable to communicate directly or indirectly with the UEs 1712 and/or with other network nodes or equipment in the telecommunication network 1702 to enable and/or provide network access, such as wireless network access, and/or to perform other functions, such as administration in the telecommunication network 1702.

In the depicted example, the core network 1706 connects the network nodes 1710 to one or more hosts, such as host 1716. These connections may be direct or indirect via one or more intermediary networks or devices. In other examples, network nodes may be directly coupled to hosts. The core network 1706 includes one more core network nodes (e.g., core network node 1708) that are structured with hardware and software components. Features of these components may be substantially similar to those described with respect to the UEs, network nodes, and/or hosts, such that the descriptions thereof are generally applicable to the corresponding components of the core network node 1708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1716 may be under the ownership or control of a service provider other than an operator or provider of the access network 1704 and/or the telecommunication network 1702, and may be operated by the service provider or on behalf of the service provider. The host 1716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1700 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1702 is a cellular network that implements 3GPP standardized features. Accordingly, the telecommunications network 1702 may support network slicing to provide different logical networks to different devices that are connected to the telecommunication network 1702. For example, the telecommunications network 1702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1712 are configured to transmit and/or receive information without direct human interaction. For instance, a UE may be designed to transmit information to the access network 1704 on a predetermined schedule, when triggered by an internal or external event, or in response to requests from the access network 1704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1714 communicates with the access network 1704 to facilitate indirect communication between one or more UEs (e.g., UE 1712c and/or 1712d) and network nodes (e.g., network node 1710b). In some examples, the hub 1714 may be a controller, router, content source and analytics, or any of the other communication devices described herein regarding UEs. For example, the hub 1714 may be a broadband router enabling access to the core network 1706 for the UEs. As another example, the hub 1714 may be a controller that sends commands or instructions to one or more actuators in the UEs. Commands or instructions may be received from the UEs, network nodes 1710, or by executable code, script, process, or other instructions in the hub 1714. As another example, the hub 1714 may be a data collector that acts as temporary storage for UE data and, in some embodiments, may perform analysis or other processing of the data. As another example, the hub 1714 may be a content source. For example, for a UE that is a VR headset, display, loudspeaker or other media delivery device, the hub 1714 may retrieve VR assets, video, audio, or other media or data related to sensory information via a network node, which the hub 1714 then provides to the UE either directly, after performing local processing, and/or after adding additional local content. In still another example, the hub 1714 acts as a proxy server or orchestrator for the UEs, in particular in if one or more of the UEs are low energy IoT devices.

The hub 1714 may have a constant/persistent or intermittent connection to the network node 1710b. The hub 1714 may also allow for a different communication scheme and/or schedule between the hub 1714 and UEs (e.g., UE 1712c and/or 1712d), and between the hub 1714 and the core network 1706. In other examples, the hub 1714 is connected to the core network 1706 and/or one or more UEs via a wired connection. Moreover, the hub 1714 may be configured to connect to an M2M service provider over the access network 1704 and/or to another UE over a direct connection. In some scenarios, UEs may establish a wireless connection with the network nodes 1710 while still connected via the hub 1714 via a wired or wireless connection. In some embodiments, the hub 1714 may be a dedicated hub—that is, a hub whose primary function is to route communications to/from the UEs from/to the network node 1710b. In other embodiments, the hub 1714 may be a non-dedicated hub—that is, a device which is capable of operating to route communications between the UEs and network node 1710b, but which is additionally capable of operating as a communication start and/or end point for certain data channels.

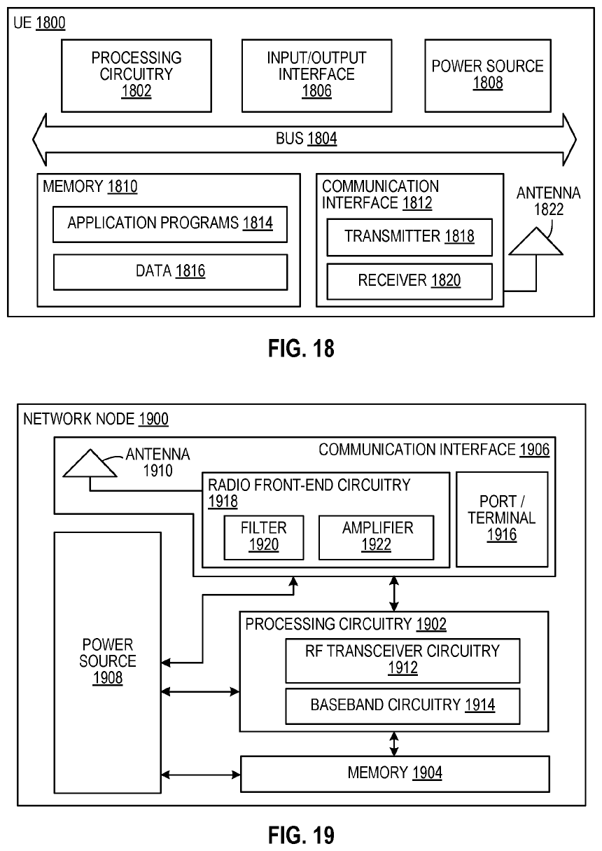

FIG. 18 shows a UE 1800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1800 includes processing circuitry 1802 that is operatively coupled via a bus 1804 to an input/output interface 1806, a power source 1808, a memory 1810, a communication interface 1812, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

The processing circuitry 1802 is configured to process instructions and data and may be configured to implement any sequential state machine operative to execute instructions stored as machine-readable computer programs in the memory 1810. The processing circuitry 1802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1802 may include multiple central processing units (CPUs).

In the example, the input/output interface 1806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1808 is structured as a battery or battery pack. Other types of power sources, such as an external power source (e.g., an electricity outlet), photovoltaic device, or power cell, may be used. The power source 1808 may further include power circuitry for delivering power from the power source 1808 itself, and/or an external power source, to the various parts of the UE 1800 via input circuitry or an interface such as an electrical power cable. Delivering power may be, for example, for charging of the power source 1808. Power circuitry may perform any formatting, converting, or other modification to the power from the power source 1808 to make the power suitable for the respective components of the UE 1800 to which power is supplied.

The memory 1810 may be or be configured to include memory such as random access memory (RAM), read-only memory (ROM), programmable read-only memory (PROM), erasable programmable read-only memory (FPROM), electrically erasable programmable read-only memory (EEPROM), magnetic disks, optical disks, hard disks, removable cartridges, flash drives, and so forth. In one example, the memory 1810 includes one or more application programs 1814, such as an operating system, web browser application, a widget, gadget engine, or other application, and corresponding data 1816. The memory 1810 may store, for use by the UE 1800, any of a variety of various operating systems or combinations of operating systems.

The memory 1810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1810 may allow the UE 1800 to access instructions, application programs and the like, stored on transitory or non-transitory memory media, to off-load data, or to upload data. An article of manufacture, such as one utilizing a communication system may be tangibly embodied as or in the memory 1810, which may be or comprise a device-readable storage medium.

The processing circuitry 1802 may be configured to communicate with an access network or other network using the communication interface 1812. The communication interface 1812 may comprise one or more communication subsystems and may include or be communicatively coupled to an antenna 1822. The communication interface 1812 may include one or more transceivers used to communicate, such as by communicating with one or more remote transceivers of another device capable of wireless communication (e.g., another UE or a network node in an access network). Each transceiver may include a transmitter 1818 and/or a receiver 1820 appropriate to provide network communications (e.g., optical, electrical, frequency allocations, and so forth). Moreover, the transmitter 1818 and receiver 1820 may be coupled to one or more antennas (e.g., antenna 1822) and may share circuit components, software or firmware, or alternatively be implemented separately.

In the illustrated embodiment, communication functions of the communication interface 1812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1800 shown in FIG. 18.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 19 shows a network node 1900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System ((SS) nodes, Self-Organizing Network (SON) nodes, positioning nodes (e.g., Evolved Serving Mobile Location Centers (F-SMLCs)), and/or Minimization of Drive Tests (MDTs).

The network node 1900 includes a processing circuitry 1902, a memory 1904, a communication interface 1906, and a power source 1908. The network node 1900 may be composed of multiple physically separate components (e.g., a NodeB component and a RNC component, or a BTS component and a BSC component, etc.), which may each have their own respective components. In certain scenarios in which the network node 1900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1900 may be configured to support multiple radio access technologies (RATs). In such embodiments, some components may be duplicated (e.g., separate memory 1904 for different RATs) and some components may be reused (e.g., a same antenna 1910 may be shared by different RATs). The network node 1900 may also include multiple sets of the various illustrated components for different wireless technologies integrated into network node 1900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1900.

The processing circuitry 1902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1900 components, such as the memory 1904, to provide network node 1900 functionality.

In some embodiments, the processing circuitry 1902 includes a system on a chip (SOC). In some embodiments, the processing circuitry 1902 includes one or more of radio frequency (RF) transceiver circuitry 1912 and baseband processing circuitry 1914. In some embodiments, the radio frequency (RF) transceiver circuitry 1912 and the baseband processing circuitry 1914 may be on separate chips (or sets of chips), boards, or units, such as radio units and digital units. In alternative embodiments, part or all of RF transceiver circuitry 1912 and baseband processing circuitry 1914 may be on the same chip or set of chips, boards, or units.

The memory 1904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1902. The memory 1904 may store any suitable instructions, data, or information, including a computer program, software, an application including one or more of logic, rules, code, tables, and/or other instructions capable of being executed by the processing circuitry 1902 and utilized by the network node 1900. The memory 1904 may be used to store any calculations made by the processing circuitry 1902 and/or any data received via the communication interface 1906. In some embodiments, the processing circuitry 1902 and memory 1904 is integrated.

The communication interface 1906 is used in wired or wireless communication of signaling and/or data between a network node, access network, and/or UE. As illustrated, the communication interface 1906 comprises port(s)/terminal(s) 1916 to send and receive data, for example to and from a network over a wired connection. The communication interface 1906 also includes radio front-end circuitry 1918 that may be coupled to, or in certain embodiments a part of, the antenna 1910. Radio front-end circuitry 1918 comprises filters 1920 and amplifiers 1922. The radio front-end circuitry 1918 may be connected to an antenna 1910 and processing circuitry 1902. The radio front-end circuitry may be configured to condition signals communicated between antenna 1910 and processing circuitry 1902. The radio front-end circuitry 1918 may receive digital data that is to be sent out to other network nodes or UEs via a wireless connection. The radio front-end circuitry 1918 may convert the digital data into a radio signal having the appropriate channel and bandwidth parameters using a combination of filters 1920 and/or amplifiers 1922. The radio signal may then be transmitted via the antenna 1910. Similarly, when receiving data, the antenna 1910 may collect radio signals which are then converted into digital data by the radio front-end circuitry 1918. The digital data may be passed to the processing circuitry 1902. In other embodiments, the communication interface may comprise different components and/or different combinations of components.

In certain alternative embodiments, the network node 1900 does not include separate radio front-end circuitry 1918, instead, the processing circuitry 1902 includes radio front-end circuitry and is connected to the antenna 1910. Similarly, in some embodiments, all or some of the RF transceiver circuitry 1912 is part of the communication interface 1906. In still other embodiments, the communication interface 1906 includes one or more ports or terminals 1916, the radio front-end circuitry 1918, and the RF transceiver circuitry 1912, as part of a radio unit (not shown), and the communication interface 1906 communicates with the baseband processing circuitry 1914, which is part of a digital unit (not shown).

The antenna 1910 may include one or more antennas, or antenna arrays, configured to send and/or receive wireless signals. The antenna 1910 may be coupled to the radio front-end circuitry 1918 and may be any type of antenna capable of transmitting and receiving data and/or signals wirelessly. In certain embodiments. the antenna 1910 is separate from the network node 1900 and connectable to the network node 1900 through an interface or port.

The antenna 1910, communication interface 1906, and/or the processing circuitry 1902 may be configured to perform any receiving operations and/or certain obtaining operations described herein as being performed by the network node. Any information, data and/or signals may be received from a UE, another network node and/or any other network equipment. Similarly, the antenna 1910, the communication interface 1906, and/or the processing circuitry 1902 may be configured to perform any transmitting operations described herein as being performed by the network node. Any information, data and/or signals may be transmitted to a UE, another network node and/or any other network equipment.

The power source 1908 provides power to the various components of network node 1900 in a form suitable for the respective components (e.g., at a voltage and current level needed for each respective component). The power source 1908 may further comprise, or be coupled to, power management circuitry to supply the components of the network node 1900 with power for performing the functionality described herein. For example, the network node 1900 may be connectable to an external power source (e.g., the power grid, an electricity outlet) via an input circuitry or interface such as an electrical cable, whereby the external power source supplies power to power circuitry of the power source 1908. As a further example, the power source 1908 may comprise a source of power in the form of a battery or battery pack which is connected to, or integrated in, power circuitry. The battery may provide backup power should the external power source fail.

Embodiments of the network node 1900 may include additional components beyond those shown in FIG. 19 for providing certain aspects of the network node's functionality, including any of the functionality described herein and/or any functionality necessary to support the subject matter described herein. For example, the network node 1900 may include user interface equipment to allow input of information into the network node 1900 and to allow output of information from the network node 1900. This may allow a user to perform diagnostic, maintenance, repair, and other administrative functions for the network node 1900.

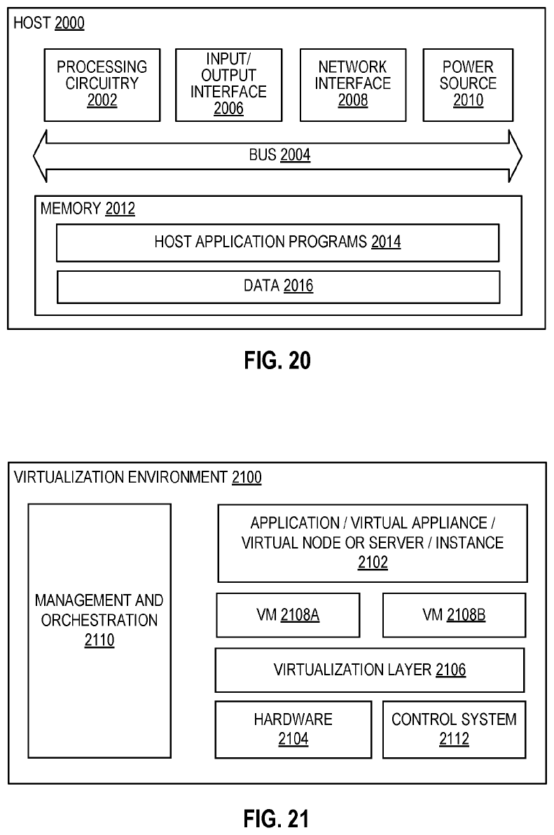

FIG. 20 is a block diagram of a host 2000, which may be an embodiment of the host 1716 of FIG. 17, in accordance with various aspects described herein. As used herein, the host 2000 may be or comprise various combinations hardware and/or software, including a standalone server, a blade server, a cloud-implemented server, a distributed server, a virtual machine, container, or processing resources in a server farm. The host 2000 may provide one or more services to one or more UEs.

The host 2000 includes processing circuitry 2002 that is operatively coupled via a bus 2004 to an input/output interface 2006, a network interface 2008, a power source 2010, and a memory 2012. Other components may be included in other embodiments. Features of these components may be substantially similar to those described with respect to the devices of previous figures, such as FIGS. 18 and 19, such that the descriptions thereof are generally applicable to the corresponding components of host 2000.

The memory 2012 may include one or more computer programs including one or more host application programs 2014 and data 2016, which may include user data, e.g., data generated by a UE for the host 2000 or data generated by the host 2000 for a UE. Embodiments of the host 2000 may utilize only a subset or all of the components shown. The host application programs 2014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2014 may also provide for user authentication and licensing checks and may periodically report health, routes, and content availability to a central node, such as a device in or on the edge of a core network. Accordingly, the host 2000 may select and/or indicate a different host for over-the-top services for a UE. The host application programs 2014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 21 is a block diagram illustrating a virtualization environment 2100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components Some or all of the functions described herein may be implemented as virtual components executed by one or more virtual machines (VMs) implemented in one or more virtual environments 2100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2106 (also referred to as hypervisors or virtual machine monitors (VMMs)), provide VMs 2108a and 2108b (one or more of which may be generally referred to as VMs 2108), and/or perform any of the functions, features and/or benefits described in relation with some embodiments described herein. The virtualization layer 2106 may present a virtual operating platform that appears like networking hardware to the VMs 2108.

The VMs 2108 comprise virtual processing, virtual memory, virtual networking or interface and virtual storage, and may be run by a corresponding virtualization layer 2106. Different embodiments of the instance of a virtual appliance 2102 may be implemented on one or more of VMs 2108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment

In the context of NFV, a VM 2108 may be a software implementation of a physical machine that runs programs as if they were executing on a physical, non-virtualized machine. Each of the VMs 2108, and that part of hardware 2104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2108 on top of the hardware 2104 and corresponds to the application 2102.

Hardware 2104 may be implemented in a standalone network node with generic or specific components. Hardware 2104 may implement some functions via virtualization. Alternatively, hardware 2104 may be part of a larger cluster of hardware (e.g. such as in a data center or CPE) where many hardware nodes work together and are managed via management and orchestration 2110, which, among others, oversees lifecycle management of applications 2102. In some embodiments, hardware 2104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2112 which may alternatively be used for communication between hardware nodes and radio units.

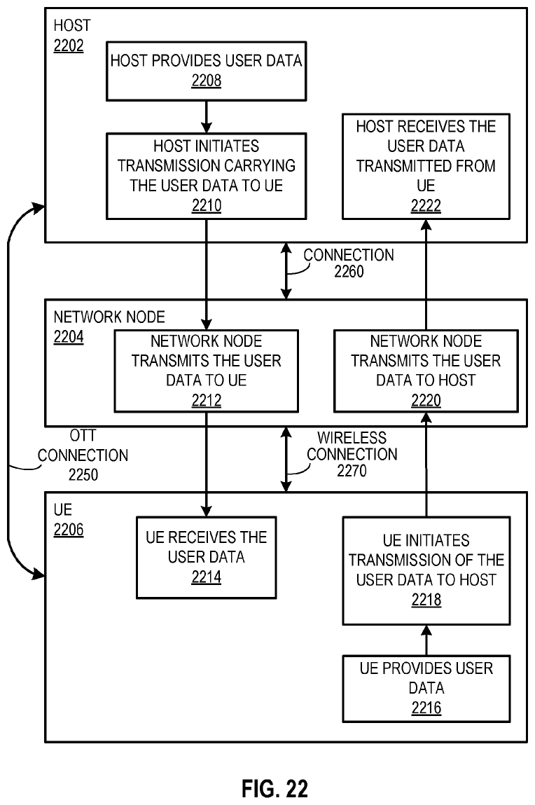

FIG. 22 shows a communication diagram of a host 2202 communicating via a network node 2204 with a UE 2206 over a partially wireless connection in accordance with some embodiments. Example implementations, in accordance with various embodiments, of the UE (such as a UE 1712a of FIG. 17 and/or UE 1800 of FIG. 18), network node (such as network node 1710a of FIG. 17 and/or network node 1900 of FIG. 19), and host (such as host 1716 of FIG. 17 and/or host 2000 of FIG. 20) discussed in the preceding paragraphs will now be described with reference to FIG. 22.

Like host 2000, embodiments of host 2202 include hardware, such as a communication interface, processing circuitry, and memory. The host 2202 also includes software, which is stored in or accessible by the host 2202 and executable by the processing circuitry. The software includes a host application that may be operable to provide a service to a remote user, such as the UE 2206 connecting via an over-the-top (OTT) connection 2250 extending between the UE 2206 and host 2202. In providing the service to the remote user, a host application may provide user data which is transmitted using the OTT connection 2250.

The network node 2204 includes hardware enabling it to communicate with the host 2202 and UE 2206. The connection 2260 may be direct or pass through a core network (like core network 1706 of FIG. 17) and/or one or more other intermediate networks, such as one or more public, private, or hosted networks. For example, an intermediate network may be a backbone network or the Internet.

The UE 2206 includes hardware and software, which is stored in or accessible by UE 2206 and executable by the UE's processing circuitry. The software includes a client application, such as a web browser or operator-specific “app” that may be operable to provide a service to a human or non-human user via UE 2206 with the support of the host 2202. In the host 2202, an executing host application may communicate with the executing client application via the OTT connection 2250 terminating at the UE 2206 and host 2202. In providing the service to the user, the UE's client application may receive request data from the host's host application and provide user data in response to the request data. The OTT connection 2250 may transfer both the request data and the user data. The UE's client application may interact with the user to generate the user data that it provides to the host application through the OTT connection 2250.

The OTT connection 2250 may extend via a connection 2260 between the host 2202 and the network node 2204 and via a wireless connection 2270 between the network node 2204 and the UE 2206 to provide the connection between the host 2202 and the UE 2206. The connection 2260 and wireless connection 2270, over which the OTT connection 2250 may be provided, have been drawn abstractly to illustrate the communication between the host 2202 and the UE 2206 via the network node 2204, without explicit reference to any intermediary devices and the precise routing of messages via these devices.

As an example of transmitting data via the OTT connection 2250, in step 2208, the host 2202 provides user data, which may be performed by executing a host application. In some embodiments, the user data is associated with a particular human user interacting with the UE 2206. In other embodiments, the user data is associated with a UE 2206 that shares data with the host 2202 without explicit human interaction. In step 2210, the host 2202 initiates a transmission carrying the user data towards the UE 2206. The host 2202 may initiate the transmission responsive to a request transmitted by the UE 2206. The request may be caused by human interaction with the UE 2206 or by operation of the client application executing on the UE 2206. The transmission may pass via the network node 2204, in accordance with the teachings of the embodiments described throughout this disclosure. Accordingly, in step 2212, the network node 2204 transmits to the UE 2206 the user data that was carried in the transmission that the host 2202 initiated, in accordance with the teachings of the embodiments described throughout this disclosure. In step 2214, the UE 2206 receives the user data carried in the transmission, which may be performed by a client application executed on the UE 2206 associated with the host application executed by the host 2202.

In some examples, the UE 2206 executes a client application which provides user data to the host 2202. The user data may be provided in reaction or response to the data received from the host 2202. Accordingly, in step 2216, the UE 2206 may provide user data, which may be performed by executing the client application. In providing the user data, the client application may further consider user input received from the user via an input/output interface of the UE 2206. Regardless of the specific manner in which the user data was provided, the UE 2206 initiates, in step 2218, transmission of the user data towards the host 2202 via the network node 2204. In step 2220, in accordance with the teachings of the embodiments described throughout this disclosure, the network node 2204 receives user data from the UE 2206 and initiates transmission of the received user data towards the host 2202. In step 2222, the host 2202 receives the user data carried in the transmission initiated by the UE 2206.

One or more of the various embodiments improve the performance of OTT services provided to the UE 2206 using the OTT connection 2250, in which the wireless connection 2270 forms the last segment. More precisely, the teachings of these embodiments may improve the latency, power consumption and/or throughput of the network and thereby provide benefits such as reduced waiting time, reduced network congestion and/or improved connectivity.

In an example scenario, factory status information may be collected and analyzed by the host 2202. As another example, the host 2202 may process audio and video data which may have been retrieved from a UE for use in creating maps. As another example, the host 2202 may collect and analyze real-time data to assist in controlling vehicle congestion (e.g., controlling traffic lights). As another example, the host 2202 may store surveillance video uploaded by a UE. As another example, the host 2202 may store or control access to media content such as video, audio, VR or AR which it can broadcast, multicast or unicast to UEs. As other examples, the host 2202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2250 between the host 2202 and UE 2206, in response to variations in the measurement results. The measurement procedure and/or the network functionality for reconfiguring the OTT connection may be implemented in software and hardware of the host 2202 and/or UE 2206. In some embodiments, sensors (not shown) may be deployed in or in association with other devices through which the OTT connection 2250 passes; the sensors may participate in the measurement procedure by supplying values of the monitored quantities exemplified above, or supplying values of other physical quantities from which software may compute or estimate the monitored quantities The reconfiguring of the OTT connection 2250 may include message format, retransmission settings, preferred routing etc.; the reconfiguring need not directly alter the operation of the network node 2204. Such procedures and functionalities may be known and practiced in the art. In certain embodiments, measurements may involve proprietary UE signaling that facilitates measurements of throughput, propagation times, latency and the like, by the host 2202. The measurements may be implemented in that software causes messages to be transmitted, in particular empty or ‘dummy’ messages, using the OTT connection 2250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1.-6. (canceled)

7. A method of operating a control unit, CU, of a network node of a wireless communications network, comprising:
receiving a message from a distributed unit, DU, of the network node indicating a change of a beam sweeping timing of a cell served by the DU in which synchronization signal blocks, SSBs, having different SSB indices are transmitted using a plurality of spatial beams according to a beam sweeping timing, wherein the change of beam sweeping timing is from an original beam sweeping timing to a new beam sweeping timing, and wherein the change of beam sweeping timing was performed in response to detecting a random access channel, RACH, configuration conflict for the cell; and
transmitting a message to a neighbor network node indicating the change of the beam sweeping timing of the cell;
wherein the message indicating the change in beam sweeping comprises an indication of SSBs affected by the change in beam sweeping timing; and
wherein the change in beam sweeping timing comprises one or more of:
a change in an association of one of the SSBs and one of the spatial beams;
a change in a direction of one of the spatial beams carrying an associated SSB;
a change in a beam direction index of a beam associated with at least one of the SSBs; and
a change in a position of transmission of one of the SSBs in an SSB burst.

8. The method of claim 7, further comprising updating a beam relationship of beams used in the cell relative to beams used in a neighbor cell based on the change in beam sweeping timing.

9. The method of claim 7, further comprising discarding existing beam relations associated with the cell.

10. The method of claim 7, wherein the message comprises an indication of a change in sweeping timing of SSBs relative to the original beam sweeping timing.

11. The method of claim 7, wherein the change in beam sweeping timing comprises a change in SSB indices of SSBs affected by the change in beam sweeping timing.

12. The method of claim 7, further comprising, prior to receiving the message from the DU, transmitting information to the DU regarding a possible RACH conflict with a neighbor cell.

13. The method of claim 12, wherein the information comprises an indication of a RACH occasion that may be subject to a conflict and/or information about a neighbor cell RACH configuration.

14. The method of claim 7, wherein the neighbor network node comprises another CU.

15.-18. (canceled)

19. A control unit, CU, of a network node comprising:
processing circuitry; and
power supply circuitry configured to supply power to the processing circuitry;
wherein the processing circuitry is configured to perform operations comprising:
receiving a message from a distributed unit, DU, of the network node indicating a change of a beam sweeping timing of a cell served by the DU in which synchronization signal blocks, SSBs, having different SSB indices are transmitted using a plurality of spatial beams according to a beam sweeping timing, wherein the change of beam sweeping timing is from an original beam sweeping timing to a new beam sweeping timing, and wherein the change of beam sweeping timing was performed in response to detecting a random access channel, RACH, configuration conflict for the cell; and
transmitting a message to a neighbor network node indicating the change of the beam sweeping timing of the cell;
wherein the message indicating the change in beam sweeping comprises an indication of SSBs affected by the change in beam sweeping timing; and
wherein the change in beam sweeping timing comprises one or more of:
a change in an association of one of the SSBs and one of the spatial beams;
a change in a direction of one of the spatial beams carrying an associated SSB;
a change in a beam direction index of a beam associated with at least one of the SSBs; and
a change in a position of transmission of one of the SSBs in an SSB burst.

20. The network node of claim 19, wherein the processing circuitry is further configured to perform operations to update a beam relationship of beams used in the cell relative to beams used in a neighbor cell based on the change in beam sweeping timing.

21.-22. (canceled)

23. The network node of claim 19, wherein the processing circuitry is further configured to perform operations to discard existing beam relations associated with the cell.

24. The network node of claim 19, wherein the message comprises an indication of a change in sweeping timing of SSBs relative to the original beam sweeping timing.

25. The network node of claim 19, wherein the change in beam sweeping timing comprises a change in SSB indices of SSBs affected by the change in beam sweeping timing.

26. The network node of claim 19, wherein the processing circuitry is further configured to, prior to receiving the message from the DU, transmit information to the DU regarding a possible RACH conflict with a neighbor cell.
